(19) United States
(12) Patent Application Publication
(10) Pub. No.: US 2001/0030789 A1
(43) Pub. Date: Oct. 18, 2001

(54) Method and apparatus for fiber optic modules

(76) Inventors: Wenbin Jiang, Thousand Oaks, CA (US); Cheng Ping Wei, Gilbert, AZ (US); Tom D. Milster, Tuson, AZ (US); Edwin D. Dair, Los Angeles, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/816,319

(22) Filed: Mar. 22, 2001

Related U.S. Application Data
(63) Continuation-in-part of application No. 09/321,308, filed on May 27, 1999.

(51) Int. Cl. H04B 10/00

(52) U.S. Cl. 359/152; 359/163

(57) ABSTRACT

Fiber optic modules and methods of assembly of fiber optic modules. Fiber optic modules include one or more printed circuit boards arranged at a an angle with a base. The one or more printed circuit boards are parallel to optical axis of one or more optoelectronic devices such as a receiver or transmitter. The one or more printed circuit boards may include a ground plane to minimize electrical cross talk. A shielded housing or cover provides shielding for electromagnetic interference. The base or shielded housing or cover may include a septum to separate the fiber optic modules into a first side and a second side and provide additional shielding to minimize crosstalk.

### CROSS REFERENCE TO RELATED APPLICATIONS

This application is a continuation-in-part application and claims the benefit of U.S. application Ser. No. 09/321,308, Attorney Docket No. 003918.P002X, filed May 27, 1999 by inventors Wenbin Jiang et al, both of which are to be assigned to E20 Communications, Inc.

This application is also related to U.S. application Ser. No. 09/320,409, Attorney Docket No. 003918.P002, filed May 26, 1999 by inventors Wenbin Jiang et al, which is also to be assigned to E20 Communications, Inc.

### FIELD OF THE INVENTION

This invention relates to fiber optic modules.

### BACKGROUND OF THE INVENTION

Fiber optic modules interface optical fibers to electronic circuitry transducing communication by light or photons with communication by electrical signals. A fiber optic module may be a fiber optic receiver, transmitter or transceiver including both receive and transmit functions. The fiber optic receiver, transmitter and transceiver each have optical elements (OE) and electrical elements (EE). The fiber optic transmitter OE includes an emitter (such as a semiconductor LED or Laser) mounted in a package and an optical coupling element for coupling light or photons from the OE into the optical fiber. The type of semiconductor laser (light amplification by stimulated emission of radiation) may be a vertical cavity surface emitting laser (VCSEL). The fiber optic receiver OE includes a photodetector (such as a photodiode) mounted in a package and an optical coupling element for coupling light or photons from the optical fiber into the photodetector. The EE for each includes integrated circuits and passive elements mounted on a substrate such as a printed circuit board (PCB) or ceramic. The OE and EE are connected electrically at the emitter and photodetector.

Because of the high transmission frequencies utilized in fiber optic communication, crosstalk between receive and transmit signals is of concern. Additionally, electromagnetic interference (EMI) is of concern due to the high frequency of operation of the fiber optic modules. In order to reduce EMI, shielding of the electrical components is required which is usually accomplished by attaching a metal shield to the substrate of the fiber optic module and connecting it to ground. In order to avoid electronic crosstalk and EMI, the fiber optic transceiver usually employs separate components and separate shielding of fiber optic receiver and fiber optic transmitter components. In order to avoid optical crosstalk where light or photons can interfere between communication channels, the fiber optic transceiver usually employs separate optical elements for coupling light or photons into and out of the optical fiber for fiber optic receiver and fiber optic transmitter. Using separate optical elements requires additional components and increases the costs of fiber optic transceivers. It is desirable to reduce the component count of fiber optic transceivers such that they are less expensive to manufacture.

The form factor or size of the fiber optic module is of concern. Previously, the fiber optic transceiver, receiver, and transmitter utilized horizontal boards or substrates which mounted parallel with a system printed circuit board utilized significant footprint or board space. The horizontal boards provided nearly zero optical crosstalk and minimal electronic crosstalk when properly shielded. However, the horizontal boards, parallel to the system printed circuit board, required large spacing between optical fiber connectors to make the connection to the optical fibers. While this may have been satisfactory for early systems using minimal fiber optic communication, the trend is towards greater usage of fiber optic communication requiring improved connectivity and smaller optical fiber connectors to more densely pack them on a system printed circuit board. Thus, it is desirable to minimize the size of system printed circuit boards (PCBs) and accordingly it is desirable to reduce the footprint of the fiber optic module which will attach to such system PCBs. Additionally, the desire for tighter interconnect leads of fiber optic cables, restricts the size of the OE's. For example, in the common implementation using TO header and can, the header dimension of the interconnect lead is normally 5.6 mm. In small form factor optical modules, such as the MT family, the two optical fibers are separated by a distance of only 0.75 mm. This severely restricts the method of coupling light or photons from the OE into and out of fiber optic cables.

### BRIEF DESCRIPTIONS OF THE DRAWINGS

FIG. 1 is a simplified top cutaway view of a first embodiment of the invention.

FIG. 2 is an exploded view of the first embodiment of the invention.

FIG. 3A is a cross-sectional view from the top of the optic block for the first embodiment of the invention.

FIG. 3B is a front side perspective view from the left of the optic block for the first embodiment of the invention.

FIG. 3C is a frontal view of the optic block for the first embodiment of the invention.

FIG. 3D is a back side perspective view from the right of the optic block for the first embodiment of the invention.

FIG. 3E is a back view of the optic block for the first embodiment of the invention.

FIG. 3F is a right side view of the optic block for the first embodiment of the invention.

FIG. 3G is a left side view of the optic block for the first embodiment of the invention.

FIG. 3H is a cross-sectional view of the optic block for the first embodiment of the invention.

FIG. 3I is a magnified cross-sectional view of the alignment post of the optic block.

FIG. 4 is a simplified top cutaway view of another embodiment of the invention.

FIG. 5A is an exploded view of the embodiment of the invention of FIG. 4.

FIG. 5B is an exploded view of an alternate embodiment of the invention of FIG. 4.

FIG. 5C is an exploded view of another alternate embodiment of the invention of FIG. 4.

FIG. 5D is an exploded view of another alternate embodiment of the invention of FIG. 4.

FIG. 6A is a cross-sectional view from the top of the optic block for embodiments of the invention.

FIG. 6B is a front side view of the optic block for the embodiments of the invention.

FIG. 6C is a back side view of the optic block for the embodiments of the invention.

FIG. 6D is a top side view of the optic block for the embodiments of the invention.

FIG. 7A is a top view of a manufacturing step of the invention.

FIG. 7B is a side view of a manufacturing step of the invention.

FIG. 8A is an exploded view of another embodiment of the invention.

FIG. 8B is perspective view of an alternate baseplate for embodiments of the invention.

FIG. 8C is a rear cross sectional view of the assembled invention illustrated in FIG. 8A.

FIG. 9A is an exploded view of another embodiment of the invention.

FIG. 9B is a rear cross sectional view of the assembled invention illustrated in FIG. 9A.

FIG. 10A is an exploded view of another embodiment of the invention.

FIG. 10B is a rear cross sectional view of the assembled invention illustrated in FIG. 10A.

FIG. 11A is an exploded view of another embodiment of the invention.

FIG. 11B is a rear cross sectional view of the assembled invention illustrated in FIG. 11A.

FIG. 12A is an exploded view of another embodiment of the invention.

FIG. 12B is a rear cross sectional view of the assembled invention illustrated in FIG. 12A.

FIG. 13 illustrates a receive optical block and a transmit optical block as an alternative to a single optical block.

FIG. 14A illustrates how the pin configuration of the fiber optic modules can plug into a socket on a host printed circuit board.

FIG. 14B illustrates how a socket configuration of the fiber optic modules can plug into a socket on a host printed circuit board.

FIG. 14C illustrates how a socket configuration of the fiber optic modules can horizontally plug into a socket on a host printed circuit board.

FIG. 15A illustrates a bottom perspective view of an alternate embodiment of the shielded housing or cover and base of the invention.

FIG. 15B illustrates a rear cross sectional view of the assembled invention illustrated in FIG. 10A substituting the alternate embodiment of the shielded housing or cover of FIG. 15A.

FIG. 15C illustrates a rear cross sectional view of the alternate embodiment of the shielded housing or cover of FIG. 15A.

FIG. 15D illustrates a cross sectional view of another alternate embodiment of the shielded housing or cover.

FIG. 15E illustrates a cross sectional view of another alternate embodiment of the shielded housing or cover.

FIG. 15F illustrates a cross sectional view of another alternate embodiment of the shielded housing or cover.

FIG. 15G illustrates a cross sectional view of another alternate embodiment of the shielded housing or cover.

FIG. 16A illustrates a rear cross sectional view of an assembled alternate embodiment of the invention.

FIG. 16B illustrates a rear cross sectional view of an assembled alternate embodiment of the invention.

### DETAILED DESCRIPTION OF THE PREFERRED EMBODIMENT

In the following detailed description of the invention, numerous specific details are set forth in order to provide a thorough understanding of the invention. However, it will be obvious to one skilled in the art that the invention may be practiced without these specific details. In other instances well known methods, procedures, components, and circuits have not been described in detail so as not to unnecessarily obscure aspects of the invention.

The invention includes a method, apparatus and system for method, apparatus and system for vertical board construction of fiber optic transmitters, receivers and transceivers. Briefly, fiber optic transmitter and receiver electrical elements are implemented on at least two separate printed circuit boards (PCBs) in a fiber optic module. The separate boards are arranged within the fiber optic module to reduce the footprint of the fiber optic module. In one embodiment, bending light or photons through ninety degrees, the light transmitter (a packaged type of emitter) and a light receiver (a packaged type of photodetector) are each mounted substantially perpendicular to the transmit and receive boards respectively such that their active areas are nearly facing each other but offset. A single optical block can be used to implement lenses and reflecting surfaces to minimize manufacturing costs. In one embodiment, the light receiver and light transmitter are mounted offset from each other in the optical block in order to avoid optical cross talk. In a second embodiment, the light transmitter (emitter) and the light receiver (photodetector) are each mounted substantially parallel with the transmit and receive boards respectively, the optical axis of transmitter and receiver and the connection to the optical fibers. The separate receive and transmit boards can be provided with ground planes in order to minimize electrical cross talk. Preferably the ground planes on the back sides of the printed circuit boards face each other. A module outer shielded housing or cover, manufactured out of metal or metal plated plastic, provides further shielding for EMI. The separate boards may be extended to support multiple channels or multiple parallel fibers such as in a ribbon optical fiber cable. Manufacturing steps of the boards for the fiber optic module are disclosed to provide reduced manufacturing costs.

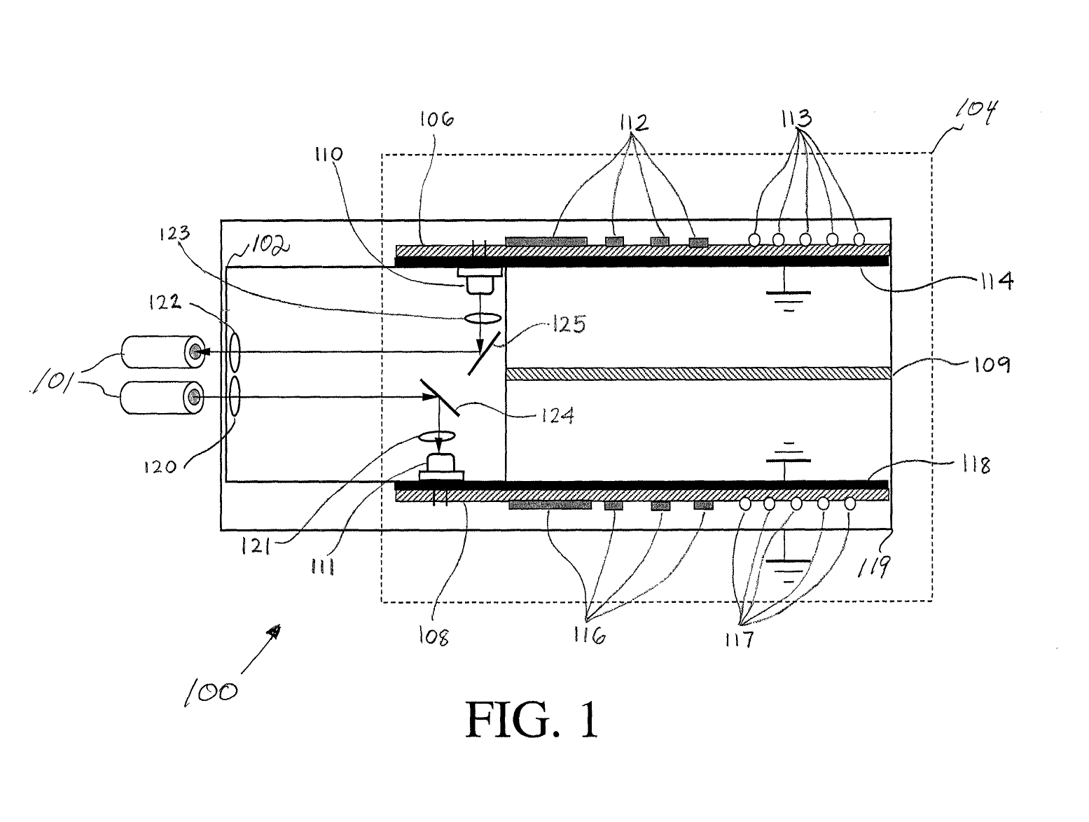

Referring now to FIG. 1, a simplified cutaway view of the first embodiment of the invention is illustrated. FIG. 1 illustrates a fiber optic module 100 coupling to a pair of fiber optic cables 101. Fiber optic module 100 includes an optical block 102 and an electrical element 104. The optical block 102 may also be referred to as a nose, an optical port, an alignment block, an optical connector, an optical receptacle or receptacle. The optical block 102 can interface to an optical connector such as an LC, MT-RJ or VF-45 optical connector. The electrical element 104 includes a transmit printed circuit board (PCB) 106, a receive PCB 108, an optional internal shield 109, a light transmitter 110, a light receiver 111, and a shielded housing or cover 119. The light transmitter 110 and light receiver 111 are optoelectronic devices for communicating with optical fibers using light of various wavelengths or photons. An optoelectronic device is a device which can convert or transduce light or photons into an electrical signal or an electrical signal into light or photons. The transmitter 110 is a packaged emitter, that converts an electrical signal into emitting light or photons, such as a semiconductor laser or LED, preferably packaged in a TO can. The receiver 111 is a packaged photodetector, that detects or receives light or photons and converts it into an electrical signal, such as a photo diode, preferably package in a TO can. However other packages, housings or covers, or optoelectronic devices for receiving and transmitting light or photon may be used for the receiver 111 or transmitter 110.

Each of the optoelectronic devices, receiver 111 and transmitter 110, have terminals. In one embodiment, terminals of one or more optoelectronic devices couple to thruholes of the PCB 106 or PCB 108 or both. In another embodiment, terminals of one or more optoelectronic devices couple to an edge connector of the PCB 106 or PCB 108 or both. In one embodiment, the transmit PCB 106 includes electrical components 112 (transmitter integrated circuit (laser driver), resistors, capacitors and other passive or active electrical components), pins 113, and a ground plane 114. The electrical components 112 control the transmitter 110 and buffer the data signal received from a system for transmission over an optical fiber. In one embodiment, the receive PCB 108 includes electrical components 116 (receiver integrated circuit (transimpedance amplifier and post amplifier), resistors, capacitors and other passive or active electrical components), pins 117, and a ground plane 118. The electrical components 116 control the receiver 111 and buffer the data signal received from an optical fiber. The ground planes 114 and 118 and the shielded housing or cover 119 are coupled to ground. In another embodiment, a pin header consisting of a dielectric medium that is molded over a plurality of pins, is used to couple to through holes in the PCB 108 or PCB 106. The electrical components 116 and pins 117 are sandwiched between the ground plane 118 and the shielding 119 to shunt electromagnetic fields to ground and avoid crosstalk in the receive PCB 108. Electrical components 112 and pins 113 are sandwiched between the ground plane 114 and the shielded housing or cover 119 to shunt electromagnetic fields generated by these components to ground and avoid crosstalk in the transmit PCB 106. Optional internal shielding 109 further provides additional crosstalk protection between printed circuit boards. If ground planes 114 and 118 are not used, then internal shielding 109 is required to reduce the electromagnetic fields that may be generated.

The optical block 102 includes lenses 120-123 and reflectors 124-125. Lenses 120-123 may be any collimating lenses including aspheric lenses, ball lenses, and GRIN lenses. Lenses 121-123 may be symmetric (circular symmetry) or asymmetric to provide optical steering. Lens 123 is for collimating the light or photons diverging from the transmitter 110 and lens 122 is for focussing the collimated light or photons into an optical fiber. Lens 120 is for collimating the light or photons diverging out from the end of an optical fiber and lens 121 is for focusing the collimated light or photons into the receiver 111. Reflectors 124-125 may be facets formed in the optical block having angles to provide total internal reflection between the optical block material and the atmosphere. Preferably they are forty five degree angle facets. Alternatively, they may be facets coated with a reflective surface or mirror surface to reflect light or photons off the reflective coated surface or facets having an optical grating surface to reflect photons. The optical block 102 is preferably constructed of a thermoplastic or polycarbonate which is clear to the desired wavelengths of light or photons. The reflectors 124-125, lenses 120-123 and other elements of the optical block 102 described below are preferably formed through injection molding of the desired material.

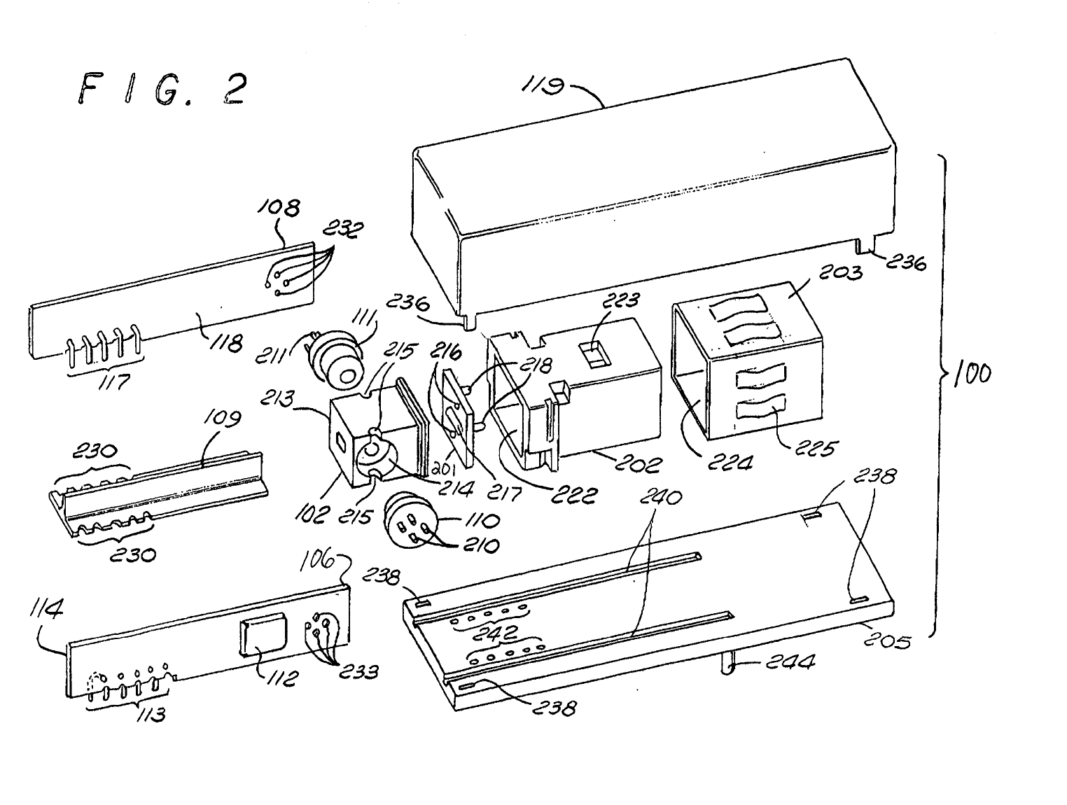

Referring to FIG. 2, an exploded diagram of the fiber optic module 100 is illustrated and its assembly is described. Transmitter 110 is inserted into an opening 214 in the optical block 102. Receiver 111 is inserted into an opening 213 in optical block 102. An epoxy is injected into top and bottom tacking holes 215 in order to hold the transmitter 110 and receiver 111 in openings 214 and 213 respectively. An MT alignment plate 201 has optical block alignment holes 216, an optical opening 217 and fiber optic connector alignment pins 218 for alignment purposes. The optical block holes 216 couple to optical block alignment pins in the optical block 102, not illustrated in FIG. 2. The fiber optic connector alignment pins 218 are for aligning optical fibers that couple to the fiber optic module 100.

For coupling to a fiber optic connector, the fiber optic module 100 has a nose 202 and a nose shield 203. The nose 202 includes a optical fiber opening 222 and a latch opening 223. The latch opening 223 receives the optical fiber connector and holds the optical fiber substantially fixed in place and aligned with the optical opening 217 of the alignment plate 201. The nose shield 203 includes an opening 224 for insertion over the nose 202 and shield tabs 225 for coupling to the ground plane of the package. The nose shielding 203 further reduces EMI.

After assembling the nose pieces to the optical block 102, the transmitter 110 and receiver 111 may be aligned to provide optimal light or photon output and reception. Alignment of the transmitter 110 and receiver 111 in optical block 102 is performed by active alignment where the receiver 111 and transmitter 110 are powered up to detect and emit photons. The receiver 111 and transmitter 110 are properly aligned in the optical block 102 to provide maximum photon detection from or coupling into fiber 101. The tacking holes 215 extend into the openings 213 and 214 such that epoxy may poured in to hold the optoelectronic devices to the optical block. After alignment is complete, the epoxy is UV cured and allowed to set such that the receiver 111 and transmitter 110 are substantially coupled to the optical block 102.

After the epoxy has set, the receive PCB 108 and the transmit PCB 106 may be attached to the receiver 111 and transmitter 110 respectively. Receiver thruholes 232 in the receive PCB 108 are aligned and slid over terminals 211 of the receiver 111. The terminals 211 are then soldered to make an electrical connection on the component side (opposite the side of the ground plane 118) of the receive PCB 108. Transmitter thruholes 233 in the transmit PCB 106 are aligned and then slid over the terminals 210 of the transmitter 110. The terminals 210 are then soldered to make an electrical connection on the component side (opposite the side of the ground plane 114) of transmit PCB 106. Ground planes 114 and 118 have sufficient material removed around the transmitter thruholes 233 and the receiver thruholes 232 respectively to avoid shorting the terminals of the transmitter 110 and receiver 111 to ground.

After coupling the PCBs 108 and 106 to the receiver 111 and transmitter 110 respectively, the assembly is inserted into the shielded housing or cover 119. The optional internal shield 109 is next assembled into the shielded housing or cover 119 between the PCBs 106 and 108. The optional internal shield 109 has pin slots 230 to surround the pins 113 and 117 and avoid shorting thereto.

The shielded housing or cover 119 includes clips or tabs 236 at each corner for mating to a base 205. The base 205 includes PCB slots 240, clip openings or slots 238 into which the clips or tabs 236 may be inserted, and base pin holes 242 into which the PCB pins 113 and 117 may be inserted. The base 205 includes a guide post 244 for mounting the fiber optic module into a system printed circuit board. The bottom of the base mounts parallel to the printed circuit board of the system such that when horizontal, the receive PCB 108 and the transmit PCB 106 are vertical and substantially perpendicular in reference to the printed circuit board of the system and the base 205. Next in assembly, the base 205 has its base pin holes 242 slid over the PCB pins 113 and 117, the printed circuit boards 106 and 108 are guided to mate with the PCB slots 240, and the clips or tabs 236 of the shielded housing or cover 119 are guided into the clip openings or slots 238. The receive PCB pins 113 and the transmit PCB pins 117 are vertical and substantially perpendicular in reference to the printed circuit board of the system and the base 205. After coupling the base 205 to the shielded housing or cover 119, the clips or tabs 236 are bent, twisted, or otherwise changed in order to hold the base 205 in place. As an alternative to clips or tabs 236 and clip openings or slots 238, the shielded housing or cover 119 may use plastic clips, or a ridge, integrated into each side that couples to base 205 appropriately. The shielded housing or cover 119, which is coupled to ground, encases the PCBs 106 and 108 to reduce the electromagnetic fields generated by the electrical components coupled thereto by shunting the electric fields to ground to reduce electromagnetic interference (EMI).

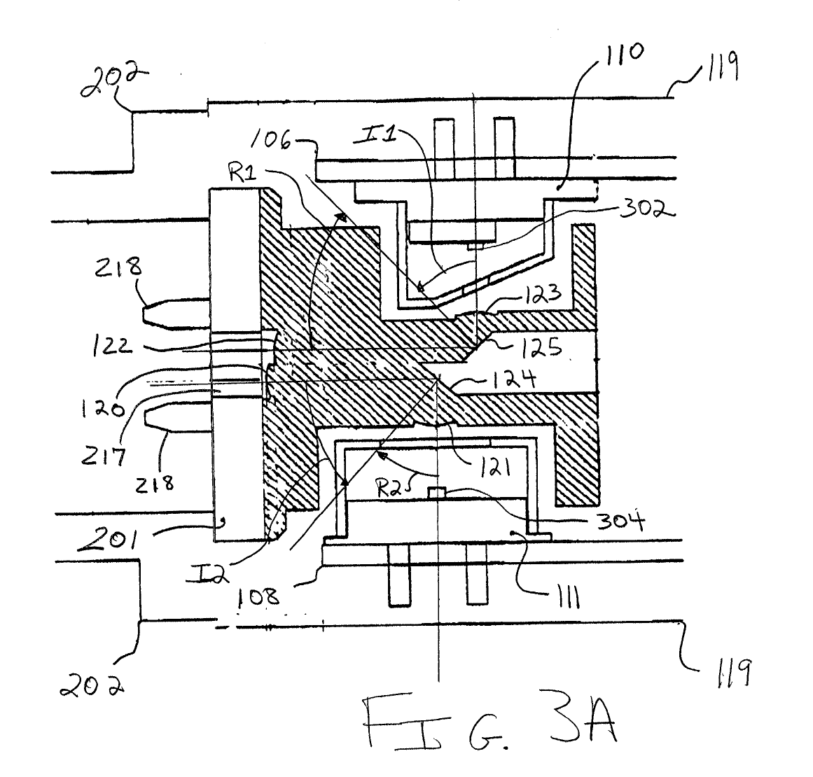

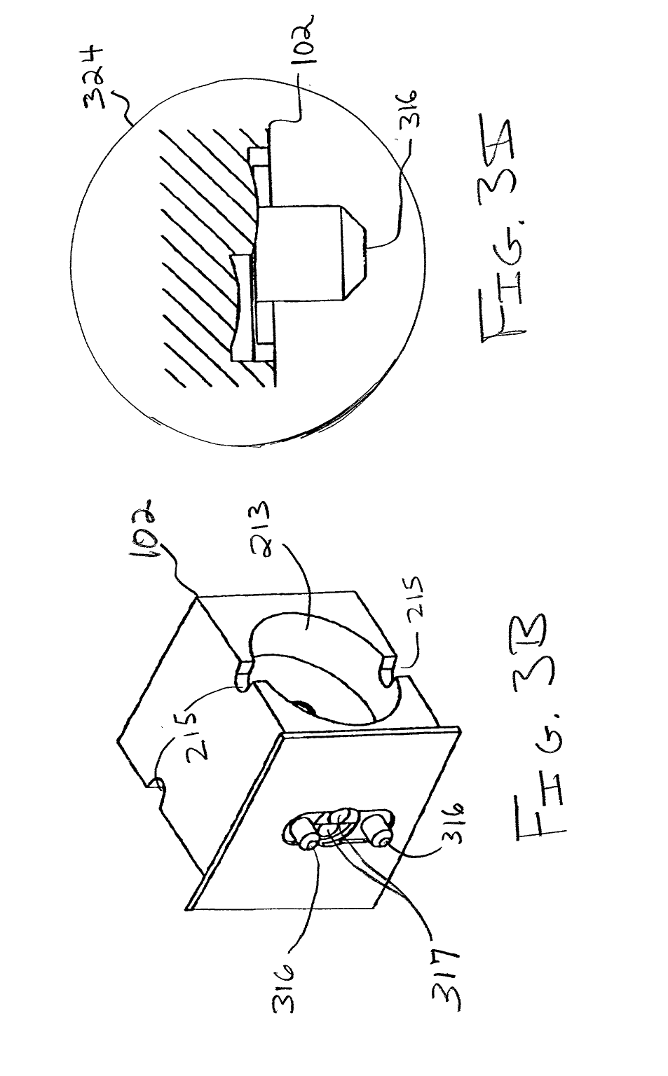

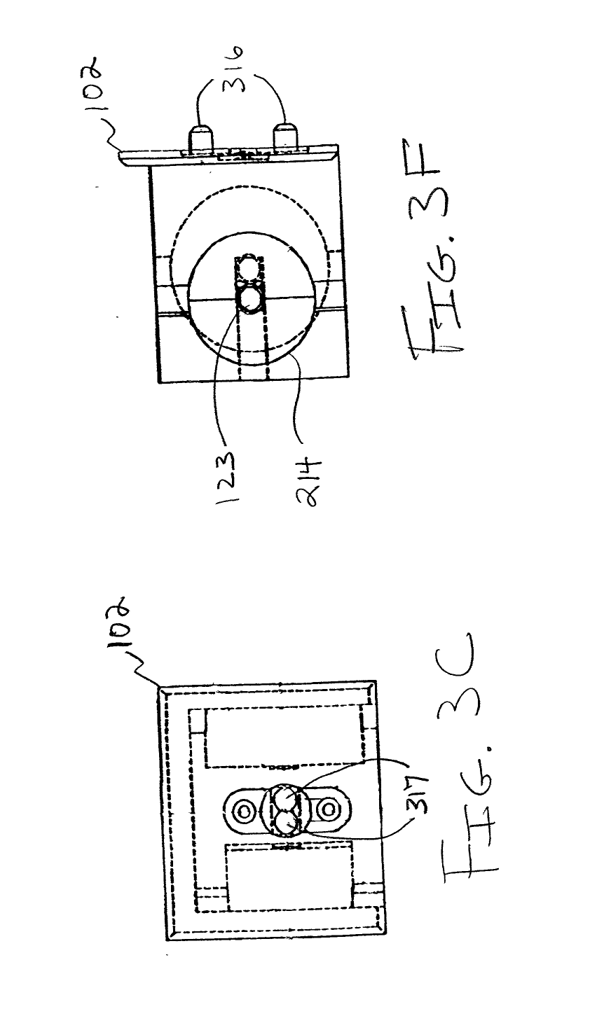

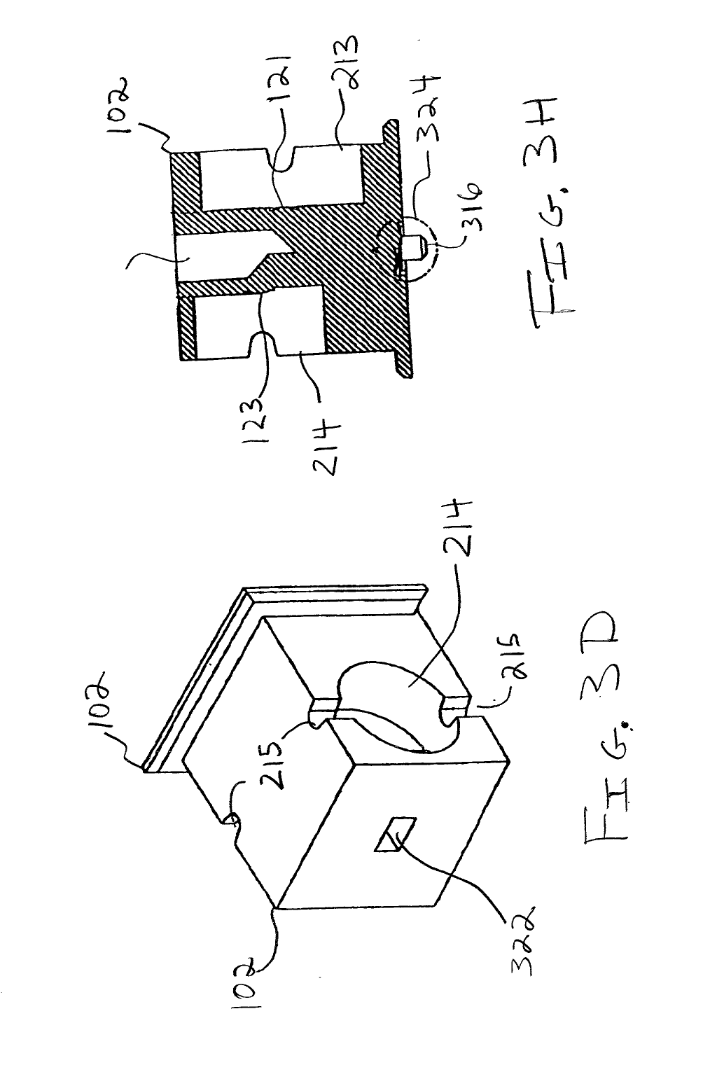

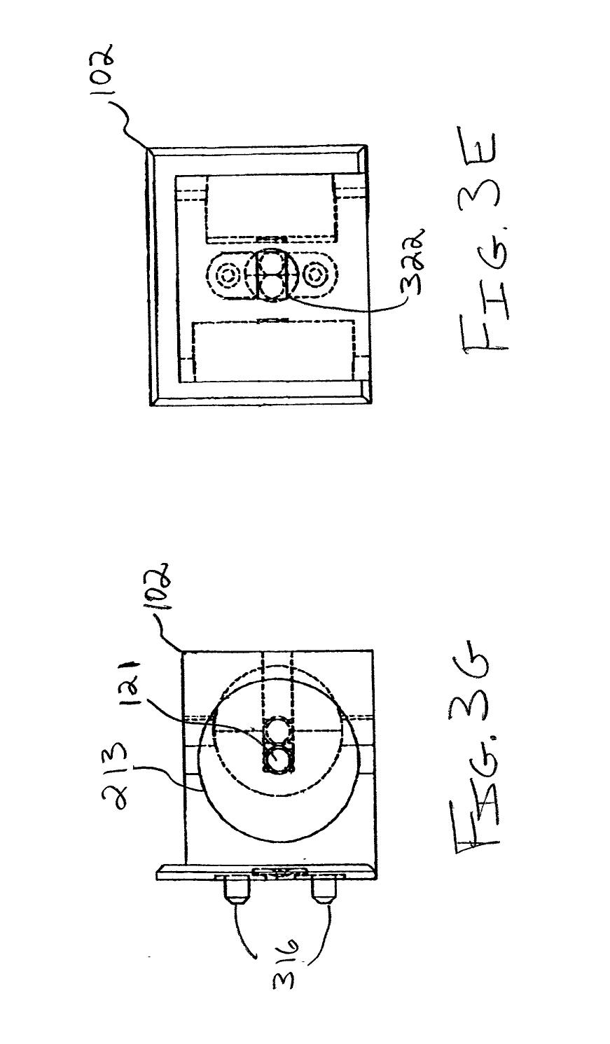

Referring now to FIG. 3A, a cross-sectional view of the optical block 102 for the first embodiment is illustrated. The transmitter 110, the receiver 111, and the MT alignment plate 201 are coupled to the optical block 102. The light transmitter 110 includes an emitter 302 for generation of light or photons in response to electrical signals from the transmit PCB 106. The light receiver 111 includes a detector 304 to receive light or photons and generate electrical signals in response to light or photons coupled thereto. Light or photons emitted by the emitter 302 are coupled into lens 123 and collimated onto the reflector 125 at an incident angle I1 (angle with the perpendicular to reflector 125 surface) preferably of substantially forty five degrees. Reflector 125 reflects the incident light or photons on a refraction angle R1 (angle with the perpendicular to reflector 125 surface) equivalent to incident angle I1 preferably of substantially forty five degrees. The reflected light or photons preferably travel perpendicular to the incident light or photons towards the lens 122. Lens 122 focuses the light or photons from the emitter 302 into an aligned optical fiber through the optical port 217 in the MT alignment plate 201. Thus, light or photons coupled or launched into an optical fiber, defining a first optical axis, are preferably substantially perpendicular to the light or photons emitted and incident upon lens 123 from the emitter 302 of the transmitter 110.

Light or photons, incident from a fiber optic cable coupled to the fiber optic module 100, is received through the optical port 217 of the MT alignment plate 201. Light or photons from the fiber optic cable are aligned to be incident upon the lens 120. Lens 120 collimates the incident light or photons from a fiber optic cable onto the reflector 124 at an incident angle I2 of preferably substantially forty five degrees. Reflector 124 reflects incident light or photons at a refractive angle R2 equivalent to incident angle I2 of preferably substantially forty five degrees towards lens 121. Lens 121 focuses the light or photons received from a fiber optical cable onto the detector 304. Light or photons incident from a fiber optic cable, defining a second optical axis, are preferably substantially perpendicular to the light or photons incident upon the detector 304.

FIG. 3B illustrates a frontal perspective view from the left side of the optical block 102. The front side of the optical block 102 includes optical block alignment pins 316 and an optical output opening 317. The optical block alignment pins 316 couple to the alignment holes 216 of the alignment plate 201 such that the optical output opening 317 is aligned with the optical port 217 in the alignment plate 201. FIG. 3C illustrates the front side of the optical block 102. The optical output opening 317 is indicated.

FIG. 3D is a back side perspective view from the right of the optical block 102. The back side of the optical block 102 includes a cavity 322 that is used to form the shape of the reflective surfaces 124-125 during manufacturing of the optical block 102. FIG. 3E is a back view of the optic block illustrating the opening into the cavity 322.

FIG. 3F illustrates the right side of the optical block 102 which has the opening 214 to mate with the type of housing of the transmitter 110. The lens 123 can be viewed near the center of the opening 214. FIG. 3G illustrates the left side of the optical block 102. which has the opening 213 to mate with the type of housing of the receiver 111. The lens 121 can be viewed near the center of the opening 213. Comparing FIGS. 3F and 3G, the offset between openings 213 and 214 to avoid optical crosstalk is visible. In the preferred embodiment, receiver 111 is closer to the optical opening 317 in order to minimize the loss of incoming received optical power. However, the position of receiver 111 and transmitter 110 can be interchanged. FIG. 3H is a cross-sectional view of the optical block 102 illustrating the relative position of the optical block alignment posts 316. The area 324 surrounding the alignment post 316 is magnified in FIG. 3I. FIG. 3I provides a magnified cross-sectional view of the alignment post 316.

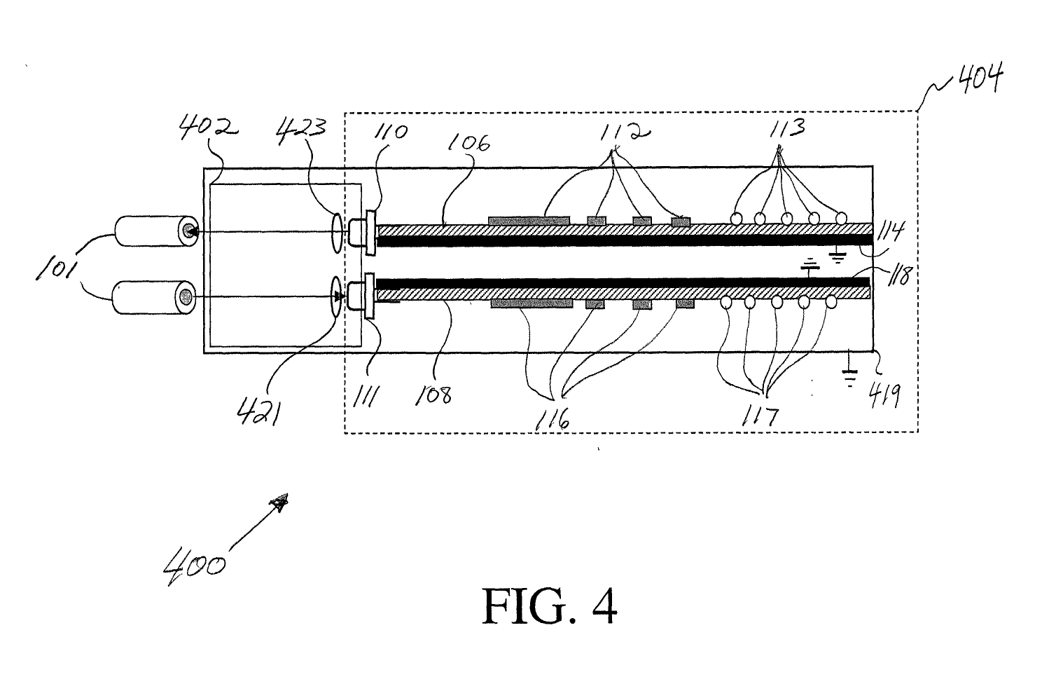

FIG. 4 illustrates another embodiment of the invention. To couple to the optical fibers 101, a fiber optic module 400 includes an optical block 402 and electrical elements 404. The optical block 402 may also be referred to as a nose, an optical port, an alignment block, an optical connector, an optical receptacle or receptacle. The optical block 402 can interface to an optical connector such as an LC, MT-RJ or VF-45 optical connector. Electrical elements 404 include transmitter PCB 106, receiver PCB 108, light receiver 111, light transmitter 110, and a shielded housing or cover 419. Shielded housing or cover 419 may be narrower than shielded housing or cover 119 due to receiver 111 and transmitter 110 being parallel with the PCBs 108 and 106. The optical or alignment block 402 may include lens 423 and lens 421 for coupling light or photons into and out of the fiber optic cable 101. Alternatively the lens 423 and 421 may be coupled to the receiver 111 and transmitter 110. Lens 423 and 421 may be spherical lenses or each may be a pair of aspheric lenses on the same optical axis. Light or photons emitted by the transmitter 110 are collected and focused by lens 423 into a transmit fiber optic cable. Light or photons on a receive fiber optic cable are collected and focused by lens 421 into the receiver 111. In this manner, fiber optic module 400 preferably keeps light or photons substantially in parallel and does not have to reflect the light or photons to couple it with receiver 111 or transmitter 110.

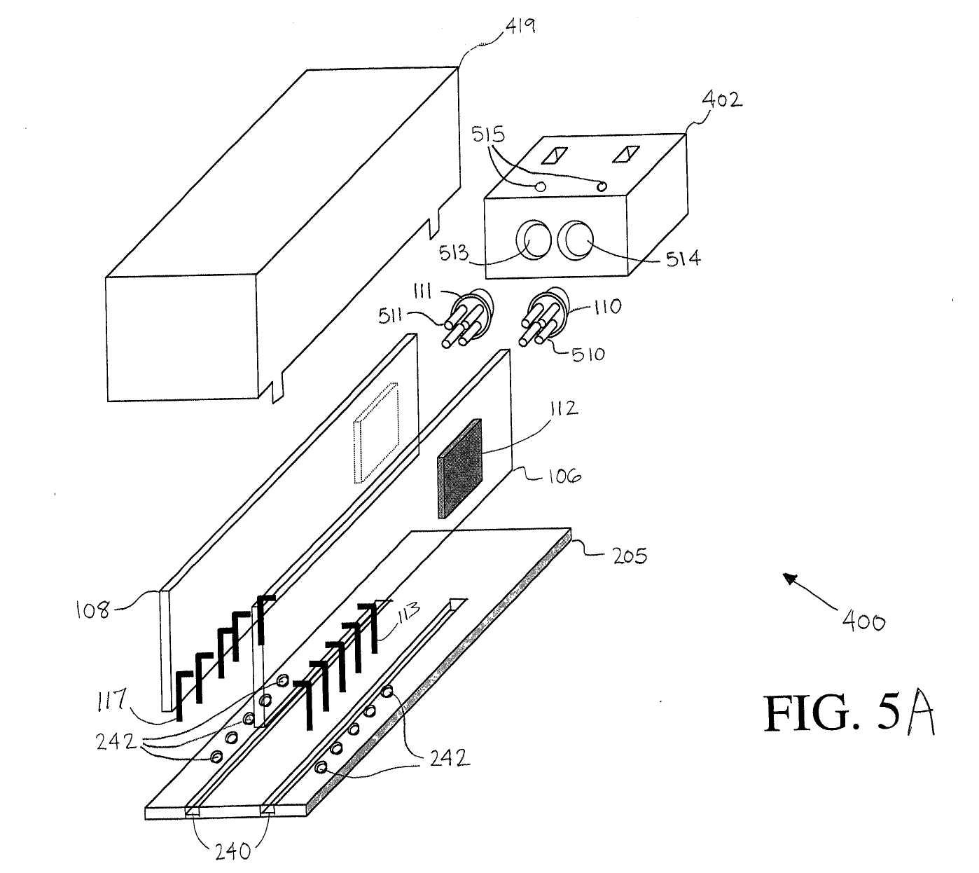

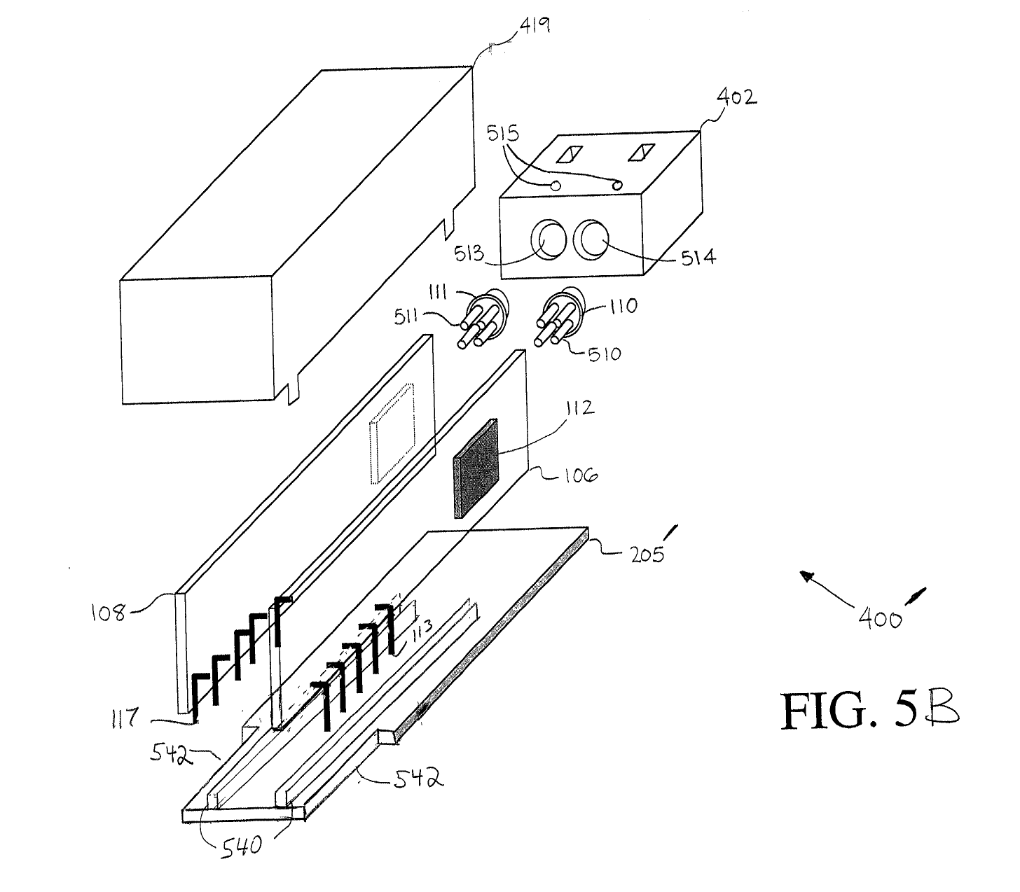

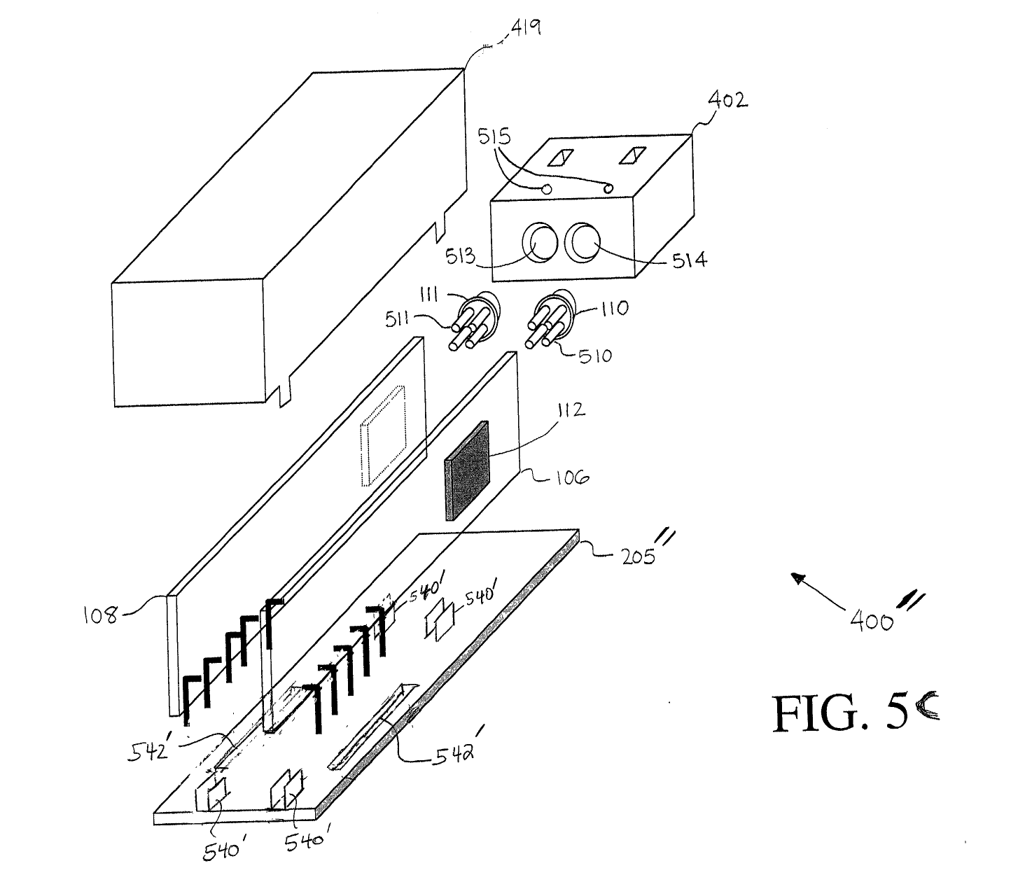

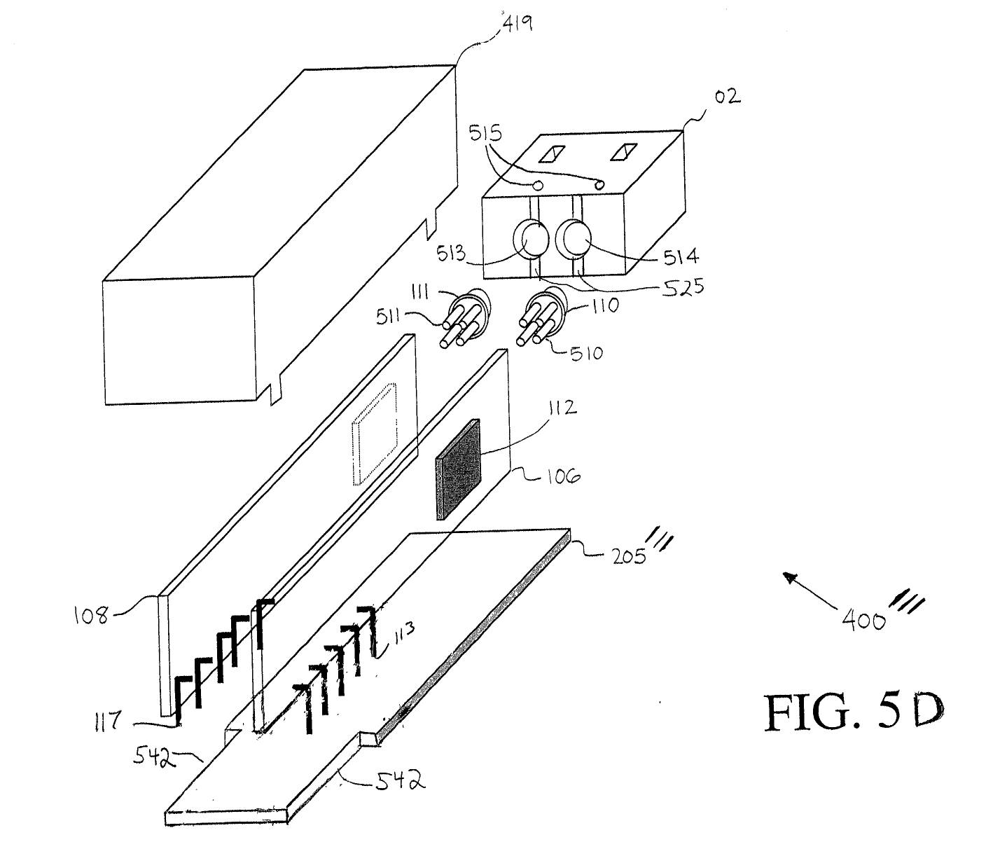

FIG. 5A illustrates an exploded diagram of the fiber optic module 400. Fiber optic module 400 is assembled similar to fiber optic module 100 as previously described with reference to FIG. 2. However, optical or alignment block 402 differs from optical block 102. Receiver 111 and transmitter 110 are inserted into openings 513 and 514 respectively in the optical or alignment block 402. The receiver and transmitter may be held in place by a press fit or glued in place. To glue in place, an epoxy or glue is injected in top and bottom tacking holes 515 of the optical or alignment block 402 while the receiver 111 and transmitter 110 are tested and aligned to substantially couple light or photons into and out of fiber optic cables. After the epoxy is set and the receiver and transmitter are substantially fixed in the optical block 102, the transmit PCB 106 and the receive PCB 108 are coupled respectively to the transmitter 110 and the receiver 111. The terminals 511 and 510 of the receiver 111 and the transmitter 110 respectively are soldered directly onto the PCB. The high frequency pins associated with the receiver 111 and transmitter 110 are preferably soldered on the component side of the printed circuit boards in order to provide proper shielding. The alignment plate 201, the nose 202 and the nose shielding 203 are unnecessary in this embodiment of the invention. Fiber ferrules are utilized instead for alignment between the optical or alignment block 402 and the optical fibers 101.

Referring now to FIG. 5B, an exploded view of a fiber optic module 400′ is illustrated. Fiber optic module 400′ is assembled similar to fiber optic module 400 as previously described with reference to FIG. 5A but a different base 205′ is utilized. The base 205′ differs from base 205 in that it has a pair of guide rails 540 to hold the PCBs 106 and 108 in place and a pair of cutouts or open slots 542 for the pins 113 and 117 to extend through. In this manner, the PCBs 106 and 108 may slide into place onto the base 205′.

Referring now to FIG. 5C, an exploded view of a fiber optic module 400″ is illustrated. Fiber optic module 400″ is assembled similar to fiber optic module 400 as previously described with reference to FIG. 5A but a different base 205″ is utilized. The base 205″ differs from base 205 in that it has pairs of mounting brackets 540′ to hold the PCBs 106 and 108 in place and a pair of openings 542′ for the pins 113 and 117 to extend through.

The PCB slots 240, guide rails 540 or brackets 540′ can be replaced by slots, brackets or guide rails of the optical block 402 to align the PCBs thereto. Additionally, it is to be understood that alternate bases may be formed by combining the elements of the bases 205, 205′, and 205″ in different ways. For example, refer to FIG. 5D. FIG. 5D illustrates an exploded view of a fiber optic module 400′″. Fiber optic module 400′″ is assembled similar to fiber optic module 400 as previously described with reference to FIG. 5A but a different base 205′″ is utilized and a slightly different optical block 502 is utilized. The base 205′″ differs from base 205 in that there are no slots 240 and that there are a pair of cutouts or open slots 542 for the pins 113 and 117 to extend through. The optical block 502 differs from the optical block 402 in that a pair of slots 525 are provided to align the PCBs 106 and 108 with the optical block.

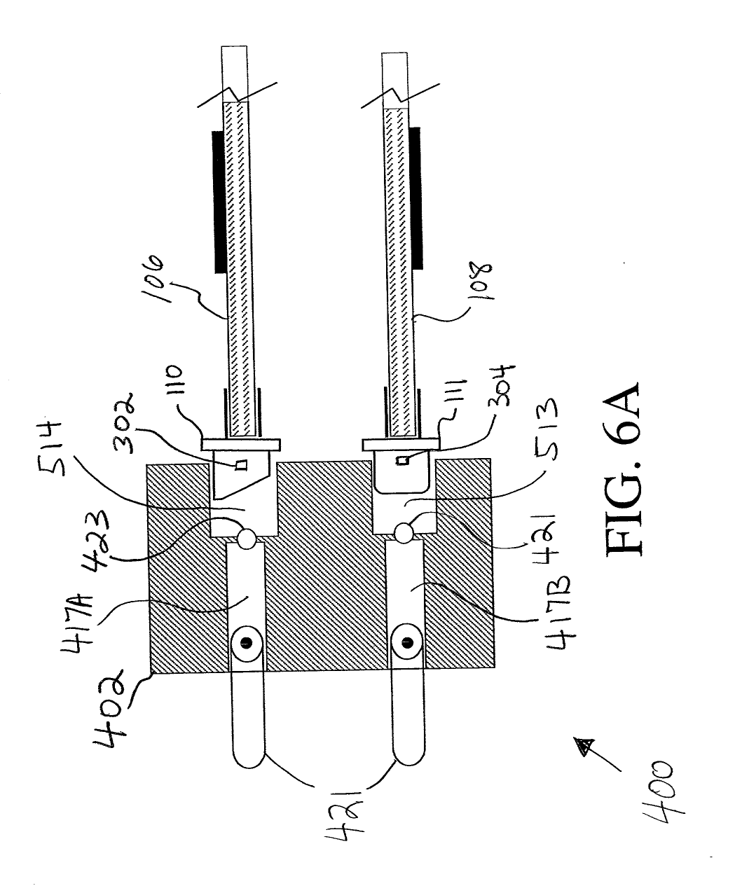

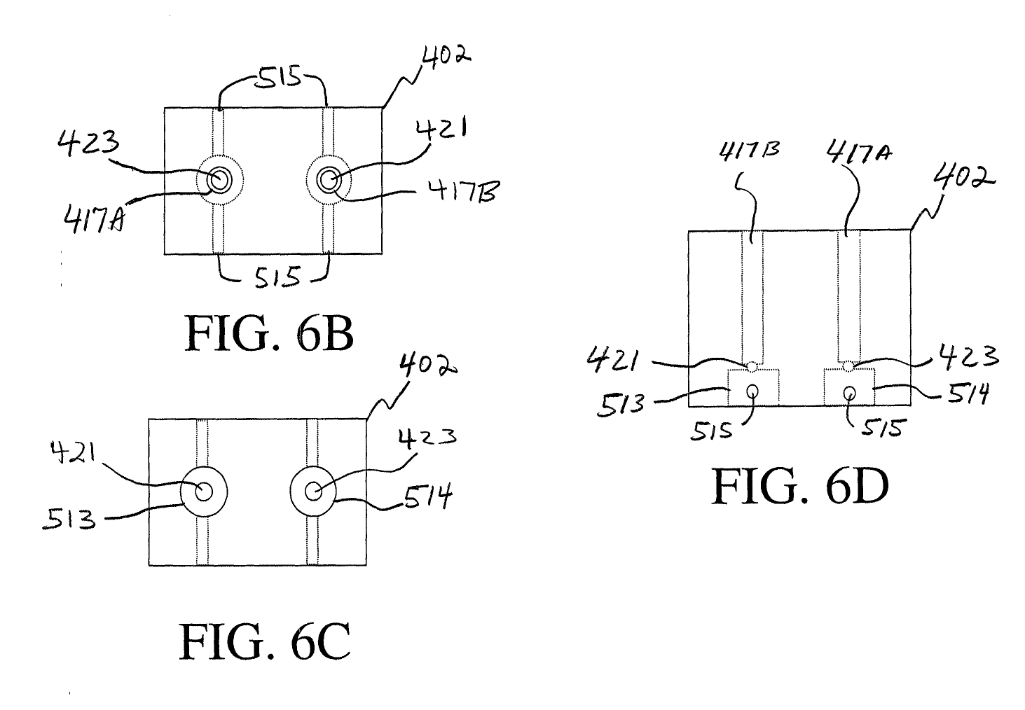

Referring now to FIG. 6A, a cross-sectional view of the optical or alignment block 402 for the second embodiment is illustrated. The transmitter 110 and the receiver 111 are coupled to the optical or alignment block 402. The transmitter 110 includes an emitter 302 for generation of light or photons. The receiver 111 includes a detector 304 to receive light or photons. Light or photons emitted by the emitter 302 are coupled into lens 423, collected and focused into the optical fiber through the optical port 417A. Light or photons, incident from a fiber optic cable coupled to the fiber optic module 400, is received through the optical port 417B. Photons from the fiber optic cable are incident upon the lens 421. Lens 421 collects and focuses the incident light or photons from the fiber optic cable onto the detector 304 of the receiver 111. In order to keep the optical fibers 101 in alignment with the optical or alignment block 402, a pair of fiber ferrules 421 are provided. The fiber ferrules 421 are inserted into the optical ports 417A and 417B.

FIG. 6B illustrates the front side of the optical or alignment block 402. The front side of the optical or alignment block 402 includes optical output ports 417A and 417B. In FIG. 6B, the lens 421 is visible through the optical output port 417B and lens 423 is visible through the optical output port 417A. FIG. 6C is an illustration of the back side of the optical or alignment block 402. In FIG. 6C, the lens 421 is visible through opening 513 and lens 423 is visible through opening 514. FIG. 6D illustrates the top side of the optical or alignment block 402 which has the tacking holes 515 coupling to the openings 513 and 514. Epoxy may be inserted into the top and bottom tacking holes 515 to hold the transmitter 110 and receiver 111 in position in the optical or alignment block 402.

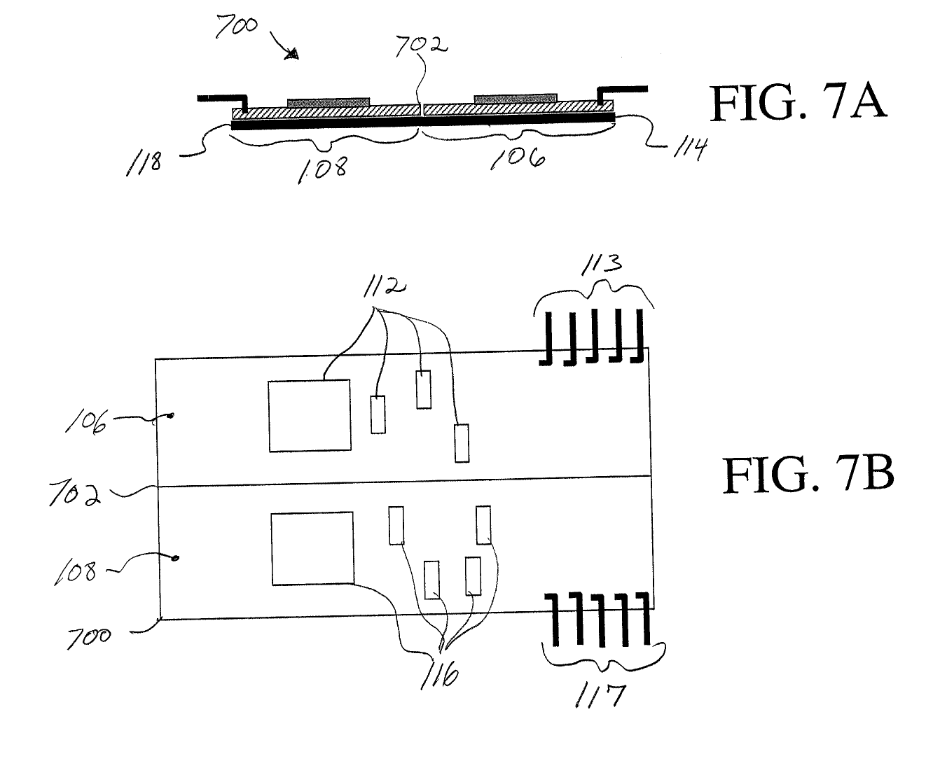

Referring now to FIGS. 7A-7B, final steps of the assembly of printed circuit boards 106 and 108 are illustrated. Transmit PCB 106 and receive PCB 108 are assembled as one unit on one printed circuit board 700 with a center score 702 defining a boundary line between transmit and receive components. After all components have been attached and assembled onto the unitary PCB 700, the PCB 700 is flexed along the score 702 such that the transmit PCB 106 and the receive PCB 108 may be separated. Transmit PCB 106 and the receive PCB 108 may thereafter be assembled as part of the fiber optic module 100 and the fiber optic module 400. The transmit PCB 106 and the receive PCB 108 may each be approximately 6.5 mm in height excluding pins 113 and 117.

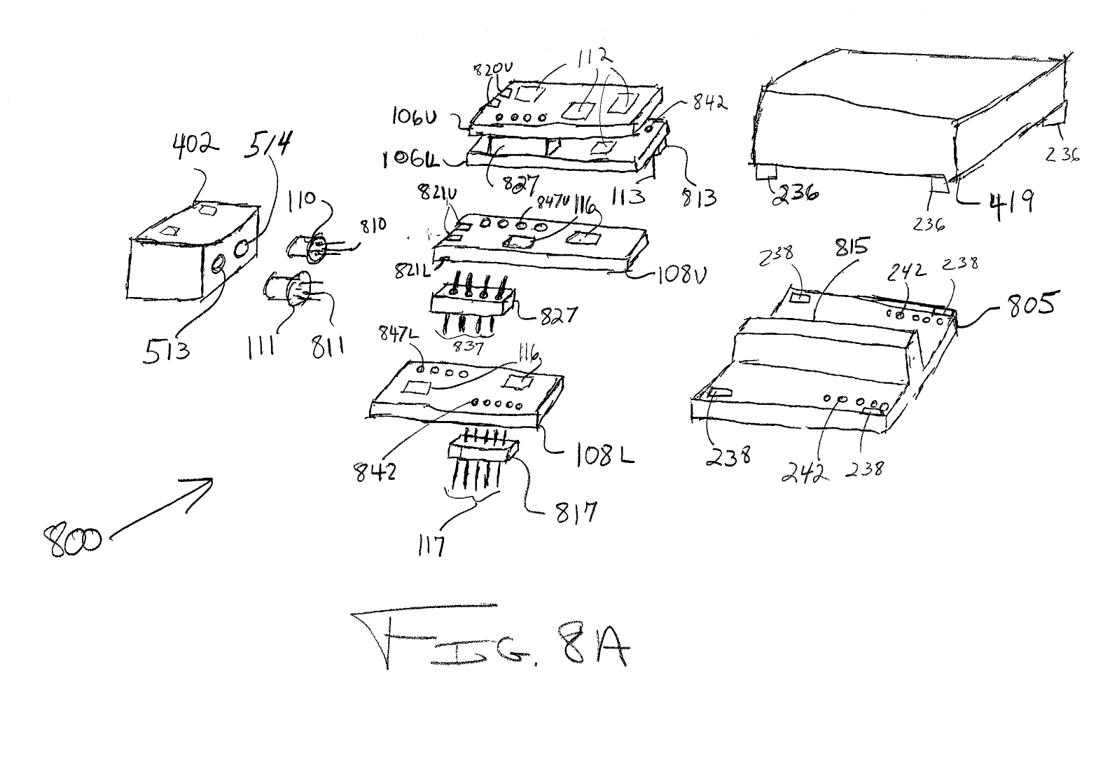

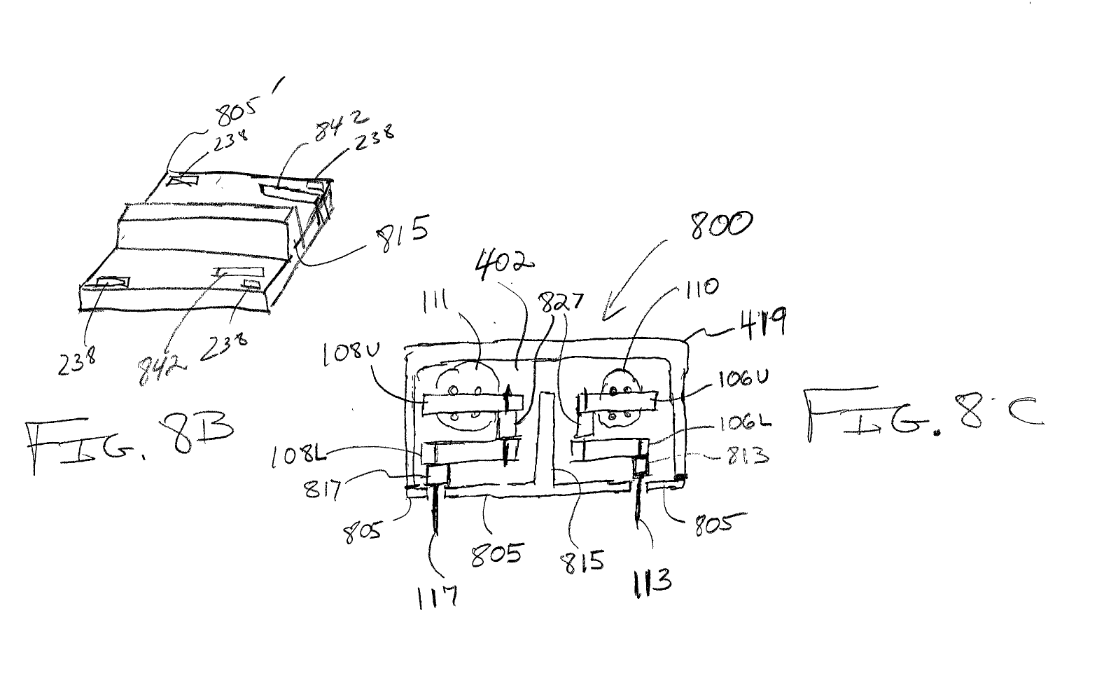

Referring now to FIG. 8A, another embodiment of the invention is illustrated. FIG. 8A illustrates an exploded view of a fiber optic module 800. The fiber optic module 800 includes an upper transmit PCB 106U, a lower transmit PCB 106L, an upper receive PCB 108U, a lower receive PCB 108L, the transmitter 110, the receiver 111, the optical block 402, the shielded housing or cover 419, a first and second PCB interconnect pin headers 827, a first terminal pin header 813 for the transmitter, a second terminal pin header 817 for the receiver, and a baseplate 805.

The transmitter 110 is a transmit optical subassembly (Tx OSA) that includes a VCSEL or other semiconductor device that transduces electrical signals into photons or a light output. The receiver 111 is a receive optical subassembly (Rx OSA) including a PIN diode or other device that converts photons or light input into electrical signals. The Tx OSA and Rx OSA are attached to physically separated transmit and receive electrical subassemblies (ESA's). In one embodiment, the transmit ESA includes an upper and lower transmit PCBs 106U and 106L with components 116 mounted thereto. In one embodiment, the receive ESA includes an upper and lower receive PCBs 108U and 108L with components 112 mounted thereto.

The lower transmit PCB 106L and the upper transmit PCB 106U provide similar functionality to that of the transmit PCB 106 and include components 112. The lower receive PCB 108L and the upper receive PCB 108U provide similar functionality to that of the receive PCB 108 and include components 116. The upper and lower transmit PCBs 106U and 106L are parallel to each other in a horizontal plane and parallel with the optical axis of the transmitter 110. The upper and lower receive PCBs 108U and 108L are parallel to each other in a horizontal plane and parallel with the optical axis of the receiver 111. This configuration of parallel horizontal boards for each of the transmit and receive capability can be referred to as dual-stack horizontal modular PCBs.

The first and second pin interconnect headers 827 include the conductive signal pins 837 molded into a non-conductive medium. The first and second pin interconnect headers 827 are used to interconnect lower and upper PCB's. The first pin header 827 provides signal interconnection between the upper and lower transmit PCBs 106U and 106L. The first pin header 827 provides signal interconnection between the upper and lower transmit PCBs 106U and 106L. The second pin header 827 provides signal interconnection between the upper and lower receive PCBs 108U and 108L. The second pin header 827 has pins 837 that couple into upper throughholes 847U in the upper receive PCB 108U and lower through holes 847L in the lower receive PCB 108L. The first pin header 827 similarly has pins 837 that couple into upper and lower throughholes in the upper and lower transmit PCBs 106U and 106L respectively.

The first and second terminal pin headers 817 and 813 include conductive signal pins molded into a non-conductive medium. The first and second terminal pin headers 817 and 813 are used to route electrical signals to and from the fiber optic module 800 to a host system. The first terminal pin header 813 has pins 113 that couple to through holes 842 in the lower transmit PCB 106L. Similarly, the second terminal pin header 817 has pins 117 that couple to through holes 842 in the lower receive PCB 108L.

The transmitter 110 couples to the upper transmit PCB 106U in one embodiment. The terminals 810 of the transmitter 110 couple to the upper transmit PCB 106U in one embodiment. Using a straddle mount, one or more terminals couple to upper edge traces 820U on a top side of the upper transmit PCB 106U and one or more terminals couple to lower edge traces 820L on a back side of the upper transmit PCB 106U. In a straddle mount, the optoelectronic device (i.e. the transmitter 110 or the receiver 111) has its optical axis nearly in-line and parallel with a plane of the printed circuit board. In an alternate embodiment, the terminals 810 may couple to the lower transmit PCB 106U. In another alternate embodiment, the terminals 810 may couple between the upper and lower receive PCBs so that one or more couple to the upper PCB and one or more couple to the lower PCB. In yet another alternate embodiment using a through hole mount, the terminals 810 may couple into holes of the upper or lower transmit PCBs or both upper and lower transmit PCBs. In a through hole mount, the optoelectronic device (i.e. the transmitter 110 or the receiver 111) has its optical axis nearly parallel with a plane of the printed circuit board.

The receiver 111 couples to the upper receive PCB 108U in one embodiment. The terminals 811 of the receiver 111 couple to the upper receive PCB 108U in one embodiment. Using a straddle mount, one or more terminals couple to upper edge traces 821U on a top side of the upper receive PCB 108U and one or more terminals couple to lower edge traces 821L on a back side of the upper receive PCB 108U. In an alternate embodiment, the terminals 811 may couple to the lower receive PCB 108U. In another alternate embodiment, the terminals 811 may couple between the upper and lower receive PCBs so that one or more couple to the upper PCB and one or more couple to the lower PCB. In yet another alternate embodiment, the terminals 811 may couple into holes of the upper or lower receive PCBs or both upper and lower receive PCBs.

Included with the fiber optic module 800 is a baseplate 805. The baseplate 805 may include an inner septum 815 that divides the transceiver and receiver into two separate cavities, for EMI and electrical isolation of the transmitter from the receiver or between channels. The baseplate 805 acts like a chassis or frame to provide support for the shielded housing or cover 419 and the receiver and transmit subassemblies. The baseplate 805 may include an inner septum 815, one or more openings 242 to receive the pins 113 and 117, and one or more clip openings or slots 238 to receive the clips or tabs 236. The baseplate 805 in one embodiment is plastic in other embodiments that baseplate may be metal or a metalized plastic to provide shielding. The inner septum 815 provides separation between the transmitter and the receiver or between channels.

Referring now to FIG. 8B, an alternate baseplate 805′ is illustrated. Baseplate 805′ differs from baseplate 805 in that it includes slots 842 for pins 113 and 117. Baseplate 805′ may similarly include clip openings or slots 238 and the inner septum 815.

Referring now to FIG. 8C, a rear cross sectional view of the assembled fiber optic module 800 is illustrated. The baseplate 805 with the inner septum 815 can divide the fiber optic module 800 into two separate cavities. The separate cavities can improve EMI and electrical isolation of the transmitter from the receiver. The receiver 111 couples to the upper receive PCB 108U with its terminals 811 using a straddle mount in one embodiment. The transmitter 111 couples to the upper transmit PCB 106U with its terminals 810 using a straddle mount in one embodiment.

In FIG. 8C, the upper and lower transmit PCBs 106U and 106L are parallel to each other in a horizontal plane and parallel with the optical axis of the transmitter 110. The upper and lower receive PCBs 108U and 108L are parallel to each other in a horizontal plane and parallel with the optical axis of the receiver 111. This configuration of parallel horizontal boards for each channel can be referred to as dual-stack horizontal modular PCBs. The dual stacked horizontal PCB's allow an increase in component surface mounting area for a given volume. Both sides of the upper and lower transmit and receive PCB's can be utilized to mount electronic components. This increased surface area can provide increased functionality in a fiber optic module by allowing additional components such as integrated circuits and passive components such as filters, capacitors, and inductors to be utilized.

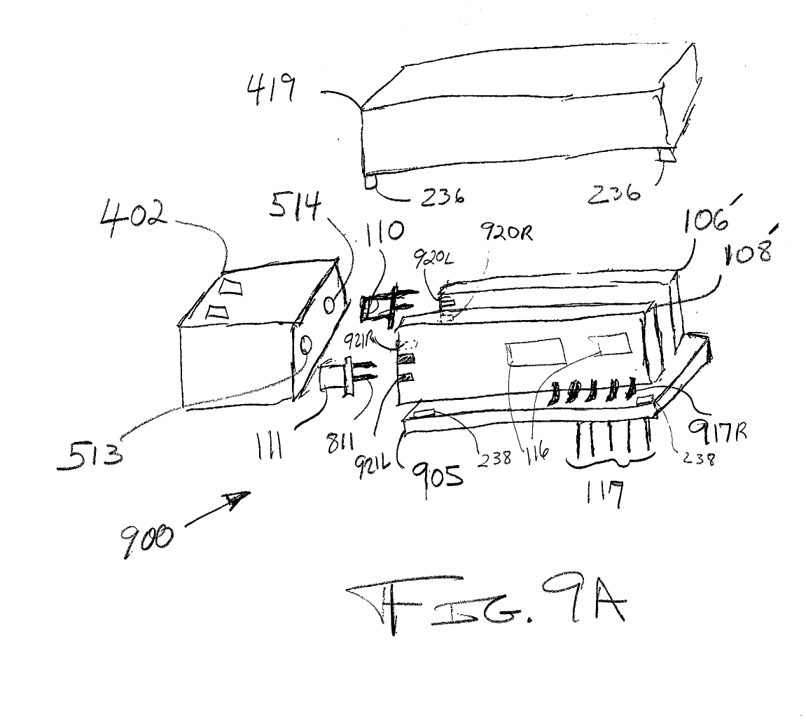

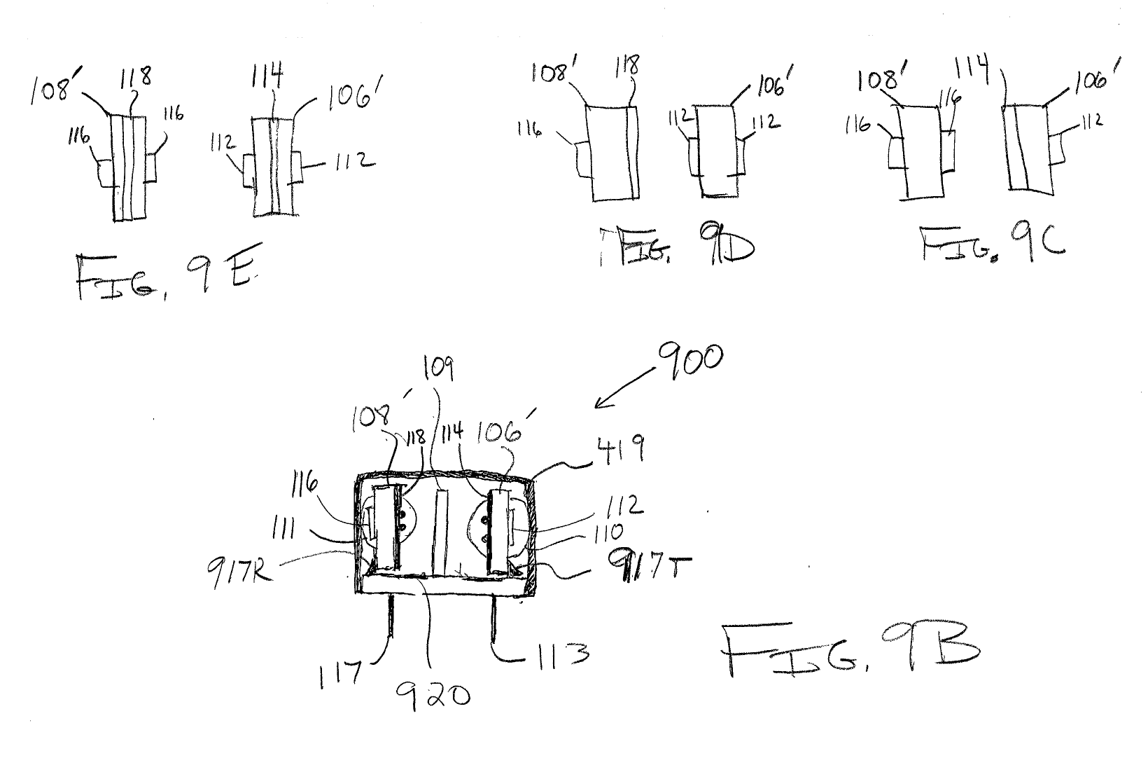

Referring now to FIG. 9A, another embodiment of the invention is illustrated. FIG. 9A illustrates an exploded view of a fiber optic module 900. The fiber optic module 900 utilizes a motherboard which is common to daughtercards PCBs which are substantially perpendicular to the motherboard. Assuming the motherboard is horizontal, the daughtercard PCBs are substantially vertical to the motherboard and can be also be referred to as vertical PCBs. The substantially vertical PCB's couple to the common motherboard.

The fiber optic module 900 includes a vertical transmit PCB 106′ and a vertical receive PCB 108′ in parallel coupled to a horizontal motherboard PCB 905. The motherboard PCB 905 can separate ground and power planes between receiver and transmitter channels in order to maximize isolation and minimize cross talk. The vertical transmit PCB and the vertical receive PCB may have traces soldered to traces of the motherboard for electrical connectivity or otherwise include pins that plugged into holes or sockets of the motherboard to ease replacement or to expand the number of transmit or receive channels with additional transmit PCBs or receive PCBs. Alternatively, the electrical connection between the vertical transmit PCB and the vertical receive PCB and motherboard PCB may be made with electrical connectors in lieu of solder joints. The mother board PCB includes Input/Output Pins (I/O Pins) or an I/O socket connector to couple to holes or a socket of a host system PCB to interface with a host system.

In order to further minimize the form factor of the fiber optic module 900, the vertical transmit PCB and the vertical receive PCB provides mounting surfaces for components on both the left and right side surfaces (or front and back surfaces). Additionally, a top surface of the motherboard PCB 905 may also be used to mount components or circuits for increased electrical functionality such as a clock/data recovery (CDR) function and minimize the form factor of the fiber optic module.

To minimize EMI and crosstalk between the vertical transmit PCB and the vertical receive PCB, an inner shield similar to the shield 109 may be used. Alternatively, one or both of the vertical transmit PCB and the vertical receive PCB may have a ground plane on of its left or right side surfaces (sometimes referred to as a backside ground plane).

The vertical PCBs 106′ and 108′ are similar to PCBs 106 and 108 but for the coupling to the horizontal motherboard PCB 905. The vertical PCBs 106′ and 108′ have signal traces soldered to signal traces of the horizontal motherboard PCB 905 which can also mechanically support the vertical PCBs 106′ and 108′. Solder joints 917R couple the receive PCB 108′ to the horizontal motherboard PCB 905. Solder joints 917T couple the transmit PCB 106′ to the horizontal motherboard PCB 905 (see FIG. 9B). The fiber optic module 900 can be referred to as having vertical PCB's with a horizontal motherboard PCB.

The horizontal motherboard PCB 905 includes input/output (I/O) pins 113 and 117 to couple to a host system and wire traces to route power, ground and signals between the pins 113 and 117 and the vertical PCBs 106′ and 108′.

The fiber optic module 900 further includes the transmitter 110, the receiver 111, the optical block 402, and the shielded housing or cover 419. The shielded housing or cover 419 has clips or tabs 236 that couple into clip openings or slots 238 in the motherboard PCB 905. The clips or tabs 236 can be held in place in the slots by a friction fit or glued in place or they may extend through the motherboard PCB 905 and be turned and or bent to couple the shielded housing or cover 419 and the motherboard PCB 905 together. Alternatively, the clips or tabs 236 of the shielded housing or cover 419 can wrap around the motherboard PCB 905 to couple them together.

The transmitter 110 couples into the opening 514 of the optical block 402. The receiver 111 couples into the opening 513 of the optical block. They are held in place by either a friction fit or a glue such as an epoxy.

The transmitter 110 couples to the transmit PCB 106′. The terminals 810 of the transmitter 110 couple to the transmit PCB 106′. In one embodiment using a straddle mount, one or more terminals 810 couple to left edge traces 920L on a left side and one or more terminals 810 couple to right edge traces 920R on a right side of the transmit PCB 106′. In alternate embodiment, the terminals 810 may couple to one side of the transmit PCB 106′. In yet another alternate embodiment, the terminals 810 may couple into holes of the transmit PCB 106′.

The receiver 111 couples to the receive PCB 108′. The terminals 811 of the receiver 111 couple to the receive PCB 108′. Using a straddle mount, one or more terminals 811 couple to left edge traces 921L on a left side and one or more terminals 811 couple to right edge traces 921R on a right side of the receive PCB 108′. In an alternate embodiment, the terminals 811 may couple to one side of the receive PCB 108′. In yet another alternate embodiment, the terminals 811 may couple into holes of the receive PCB 108′.

Referring now to FIG. 9B, a rear cross-sectional view of the assembled fiber optic module 900 is illustrated. Traces 920 on the motherboard PCB route signals to components on the motherboard PCB, the I/O pins 113 and 117, and the solder joints 917R and 917T. A ground plane 118 can be coupled to a side the vertical receive PCB 108′ or a ground plane 114 can be coupled to a side of the vertical transmit PCB 106′ or both. Referring to FIG. 9C, the vertical transmit PCB 106′ includes the ground plane 114 and the vertical receive PCB 108′ is without a ground plane to allow room for added components 116 on each side. Referring to FIG. 9D, the vertical receive PCB 108′ includes the ground plane 118 and the vertical transmit PCB 106′ is without a ground plane to allow room for added components 112 on each side. An optional inner shield 109 can also be used for further isolation between channels to reduce cross-talk and EMI as illustrated in FIG. 9B. In any case, the ground plane 114 and 118 will have cutouts for traces to coupled to the terminals 810 and 811 and may have additional cutouts for components 112 or 116 as the case may be. Referring now to FIG. 9E, the ground plane 118 or the ground plane 114 may be alternatively sandwiched between layers of either the vertical receive PCB 108′ or the vertical transmit PCB 106′ or both as a part of a multilayer PCB as illustrated by FIG. 9C. This can allow for further components 116 and 112 to be added to both sides of the vertical receive PCB 108′ and the vertical transmit PCB 106′.

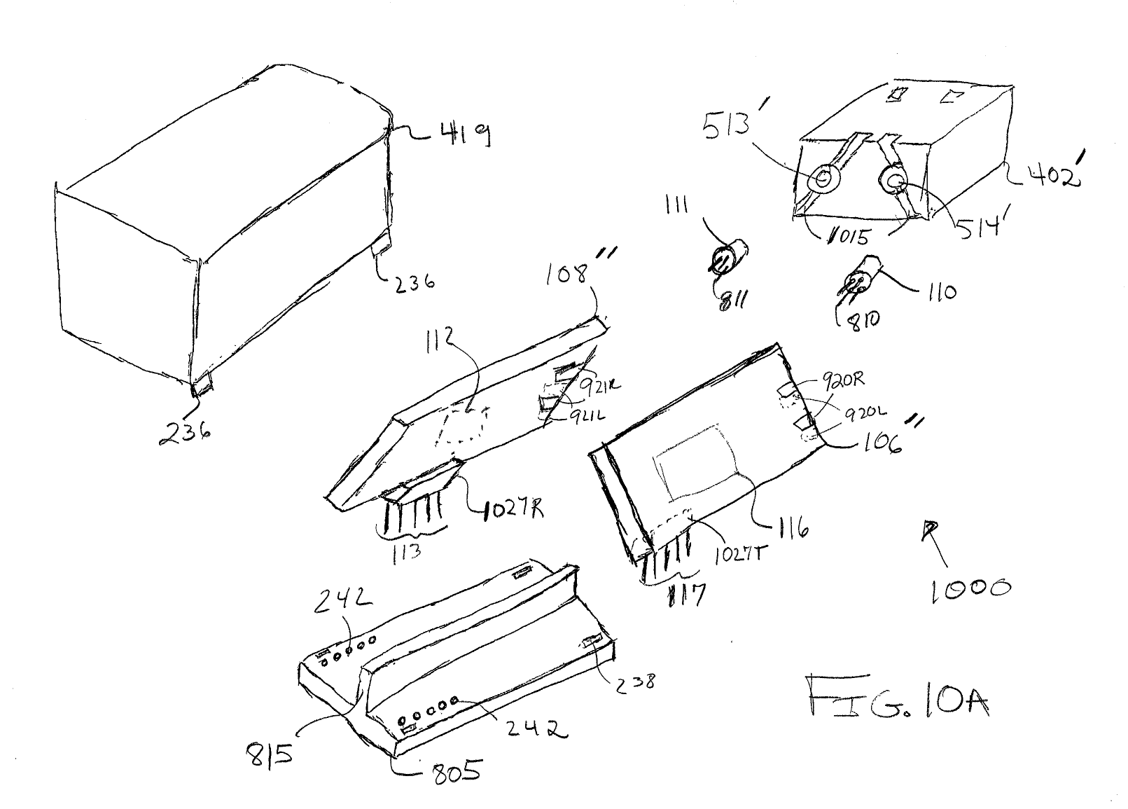

Referring now to FIG. 10A, another embodiment of the invention is illustrated. FIG. 10A illustrates an exploded view of a fiber optic module 1000. The fiber optic module 1000 has angled PCBs with respect to a horizontal or vertical axis of the fiber optic module 1000. The length of the PCBs remain parallel to the optical axis of the receiver 111 and transmitter 110. By angling the PCBs with the horizontal or vertical axis, the PCBs may be made smaller to fit a smaller form factor or alternatively the surface area can be increased. That is the available PCB surface area for mounting components can be increased for a given volume by angling the PCBs. The increased surface area can give the final assembled fiber optic module increased functionality by allowing components such as integrated circuits and passive components such as filters, capacitors, and inductors to be added. More room can also be provided in the fiber optic module 1000 for mounting larger components by angling the PCBs.

The fiber optic module 1000 includes an angled transmit PCB 106″, an angled receive PCB 108″, the transmitter 110, the receiver 111, an optical block 402′, the shielded housing or cover 419, a first terminal pin header 1027T for the transmitter, a second terminal pin header 1027R for the receiver, and the baseplate 805 or 805′.

The angled transmit PCB 106″ and the angled receive PCB 108″ are arranged within the fiber optic module at an angle with respect to the horizontal axis thereof as defined by a line normal to both receiver and transmitter optical axes. The angled transmit PCB 106″ and the angled receive PCB 108″ are held in place having a width that is on an angle with respect to a horizontal or vertical axis of the fiber optic module 1000. The length of the angled transmit PCB 106″ and the angled receive PCB 108″ are parallel to the optical axis of the receiver 111 and transmitter 110. The angled transmit PCB 106″ includes components 116 and left and right edge traces 921L and 921R. The first terminal pin header 1027T has pins 117 that couple to holes of the angled transmit PCB 106″ on one end. The angled receive PCB 108″ includes components 112 and left and right edge traces 920L and 920R. The second terminal pin header 1027R has pins 113 that couple to holes of the angled receive PCB 108″ on one end.

The transmitter 110 is a transmit optical subassembly (Tx OSA) that includes a VCSEL or other semiconductor device that transduces electrical signals into photons or a light output. The receiver 111 is a receive optical subassembly (Rx OSA) including a PIN diode or other device that converts photons or light input into electrical signals. The Tx OSA and Rx OSA are attached to physically separated transmit and receive electrical subassemblies (ESA's). In one embodiment, the transmit ESA includes the angled transmit PCB 106″ with components 116 and the first terminal pin header 1027T mounted thereto. In one embodiment, the receive ESA includes the angled receive PCB 108″ with components 112 and the second terminal pin header 1027R mounted thereto.

The optical block 402′ is similar to the optical block 402 but has some modifications to accommodate the angled transmit PCB 106″ and the angled receive PCB 108″. The optical block 402′ includes openings 513′ and 514′ to receive the receiver 111 and transmitter 110 respectively and angled slots 1015 to receive the angled transmit PCB 106″ and the angled receive PCB 108″. The angled slots 1015 can provide a friction fit with the angled transmit PCB 106″ and the angled receive PCB 108″ or glue or epoxy can be used to couple them together. The angled slots 1015 can also serve to tack the receiver 111 and transmitter 110 in place within the optical block 402′.

The transmitter 110 couples into the opening 514′ of the optical block 402′. The receiver 111 couples into the opening 513′ of the optical block 402′. They can be held in place by either a friction fit or a glue such as an epoxy.

The transmitter 110 also couples to the transmit PCB 106″. The terminals 810 of the transmitter 110 couple to the transmit PCB 106″ in one embodiment. Using a straddle mount, one or more terminals 810 couple to left edge traces 920L on a left side and one or more terminals 810 couple to right edge traces 920R on a right side of the transmit PCB 106″. In an alternate embodiment, the terminals 810 may couple to one side of the transmit PCB 106″. In yet another alternate embodiment, the terminals 810 may couple into holes of the transmit PCB 106″.

The receiver 111 also couples to the receive PCB 108″. The terminals 811 of the receiver 111 couple to the receive PCB 108″. Using a straddle mount, one or more terminals 811 couple to left edge traces 921L on a left side and one or more terminals 811 couple to right edge traces 921R on a right side of the receive PCB 108″. In an alternate embodiment, the terminals 811 may couple to one side of the receive PCB 108″. In yet another alternate embodiment, the terminals 811 may couple into holes of the receive PCB 108″.

Referring now to FIG. 10B, a rear cross-sectional view of the assembled fiber optic module 1000 is illustrated. The first terminal pin header 1027T is coupled to the angled transmit PCB 1027T so that pins 117 are vertical with the reference axis. The second terminal pin header 1027R is coupled to the angled receive PCB 108″ so that pins 113 are vertical with the reference axis. A ground plane 118 can be coupled to a side the angled receive PCB 108″ or a ground plane 114 can be coupled to a side of the angled transmit PCB 106″ or both similar to previously described with reference to the vertical boards and FIGS. 9B-9E. The shield housing or cover 419 couples to the base or baseplate 805 or 805′ around the printed circuit boards. Depending upon the width of the printed circuit boards 106′ and 108′ and the width of the fiber optic module 1000, the angles θ1 and θ2 which the printed boards make with the base or baseplate 805 or 805′ can vary between zero and ninety degrees.

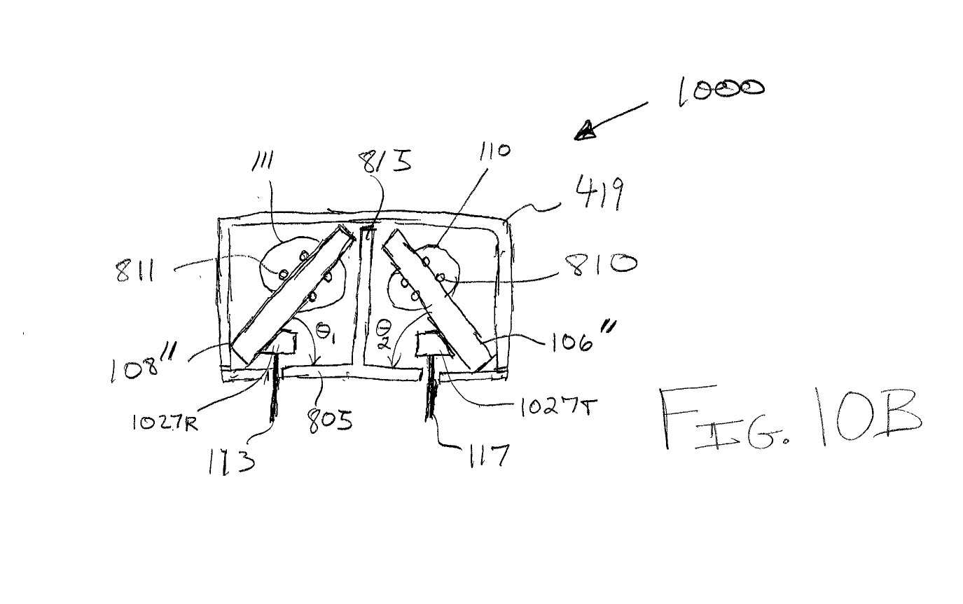

Referring now to FIG. 11A, another embodiment of the invention is illustrated. FIG. 11A illustrates an exploded view of a fiber optic module 1100. The fiber optic module 1100 has parallel angled or slanted PCBs with respect to a horizontal or vertical axis of the fiber optic module 1100. The length of the PCBs remain parallel to the optical axis of the receiver 111 and transmitter 110. By parallel angling the PCBs with the horizontal or vertical axis, the PCBs may be made smaller to fit a smaller form factor or alternatively the surface area can be increased. That is the available PCB surface area for mounting components can be increased for a given volume by angling the PCBs. The increased surface area can give the final assembled fiber optic module increased functionality by allowing components such as integrated circuits and passive components such as filters, capacitors, and inductors to be added. More room can also be provided in the fiber optic module 1100 for mounting larger components by angling the PCBs in parallel together.

The fiber optic module 1100 includes an angled transmit PCB 106′″, an angled receive PCB 108′″, the transmitter 110, the receiver 111, an optical block 402″, the shielded housing or cover 419, a first terminal pin header 1027T′ for the transmitter, a second terminal pin header 1027R′ for the receiver, and a baseplate 805″.

The angled transmit PCB 106′″ and the angled receive PCB 108′″ are arranged in parallel and at an angle with respect to a horizontal datum plane that passes through and is normal to receiver and transmitter optical axes. The angled transmit PCB 106′″ and the angled receive PCB 108′″ are slanted in parallel to the right but can be easily arranged so as to slant in parallel to the left. The angled transmit PCB 106′″ and the angled receive PCB 108′″ are held in place having a width that is on an angle with respect to a horizontal or vertical axis of the fiber optic module 1100. The length of the angled transmit PCB 106′″ and the angled receive PCB 108′″ are parallel to the optical axis of the receiver 111 and transmitter 110. The angled transmit PCB 106′″ includes components 116 and left and right edge traces 921L and 921R. The first terminal pin header 1027T′ has pins 117 that couple to holes of the angled transmit PCB 106′″ on one end. The angled receive PCB 108′″ includes components 112 and left and right edge traces 920L and 920R. The second terminal pin header 1027R′ has pins 113 that couple to holes of the angled receive PCB 108′″ on one end.

The transmitter 110 is a transmit optical subassembly (Tx OSA) that includes a VCSEL or other semiconductor device that transduces electrical signals into photons or a light output. The receiver 111 is a receive optical subassembly (Rx OSA) including a PIN diode or other device that converts photons or light input into electrical signals. The Tx OSA and Rx OSA are attached to physically separated transmit and receive electrical subassemblies (ESA's). In one embodiment, the transmit ESA includes the angled transmit PCB 106′″ with components 116 and the first terminal pin header 1027T′ mounted thereto. In one embodiment, the receive ESA includes the angled receive PCB 108′″ with components 112 and the second terminal pin header 1027R′ mounted thereto.

The baseplate 805″ is similar to the baseplate 805 and 805′ but has angled inner septum 815′ to be angled in parallel with the angled transmit PCB 106′″ and the angled receive PCB 108′″. The baseplates 805, 805′, 805″ in one embodiment may be a dielectric to isolate components and insulate them from one another. In another embodiment, baseplates 805, 805′, 805″ may be an insulator. In another embodiment, baseplates 805, 805′, 805″ may have their septum 815 or 815′ metalized so as to provide EMI and crosstalk shielding. Alternatively, a metal shield my be placed on top of the septum 815 or 815′ such as shield 109.

The optical block 402″ is similar to the optical block 402 but has some modifications to accommodate the angled transmit PCB 106′″ and the angled receive PCB 108′″. The optical block 402″ includes openings 513″ and 514″ to receive the receiver 111 and transmitter 110 respectively and angled slots 1115 to receive the angled transmit PCB 106′″ and the angled receive PCB 108′″. The angled slots 1115 can provide a friction fit with the angled transmit PCB 106′″ and the angled receive PCB 108′″ or glue or epoxy can be used to couple them together. The angled slots 1115 can also serve to tack the receiver 111 and transmitter 110 in place within the optical block 402″.

The transmitter 110 couples into the opening 514″ of the optical block 402″. The receiver 111 couples into the opening 513″ of the optical block 402″. They can be held in place by either a friction fit or a glue such as an epoxy.

The transmitter 110 also couples to the transmit PCB 106′″. The terminals 810 of the transmitter 110 couple to the transmit PCB 106′″ in one embodiment. Using a straddle mount, one or more terminals 810 couple to left edge traces 920L on a left side and one or more terminals 810 couple to right edge traces 920R on a right side of the transmit PCB 106′″. In an alternate embodiment, the terminals 810 may couple to one side of the transmit PCB 106′″. In yet another alternate embodiment, the terminals 810 may couple into holes of the transmit PCB 106′″.

The receiver 111 also couples to the receive PCB 108′″. The terminals 811 of the receiver 111 couple to the receive PCB 108′″. Using a straddle mount, one or more terminals 811 couple to left edge traces 921L on a left side and one or more terminals 811 couple to right edge traces 921R on a right side of the receive PCB 108′″. In an alternate embodiment, the terminals 811 may couple to one side of the receive PCB 108′″. In yet another alternate embodiment, the terminals 811 may couple into holes of the receive PCB 108′″.

Referring now to FIG. 11B, a rear cross-sectional view of the assembled fiber optic module 1100 is illustrated. The angled receive PCB 108′″ and the angled transmit PCB 106′″ of the fiber optic module 1100 are angled in parallel together with respect to a horizontal or vertical axis thereof. The first terminal pin header 1027T′ is coupled to the angled transmit PCB 1027T′ so that pins 117 are vertical with the reference axis. The second terminal pin header 1027R′ is coupled to the angled receive PCB 108′″ so that pins 113 are vertical with the reference axis. A ground plane 118 can be coupled to a side the angled receive PCB 108′″ or a ground plane 114 can be coupled to a side of the angled transmit PCB 106′″ or both similar to previously described with reference to the vertical boards and FIGS. 9B-9E. The shield housing or cover 419 couples to the baseplate 805″ around the printed circuit boards. Depending upon the width of the printed circuit boards 106′″ and 108′″ and the width of the fiber optic module 1100, the angles θ₃ and θ₄ which the printed boards make with the base or baseplate 805″ and the angle θ₅ which the septum 815′ makes with the base or baseplate 805″ can vary between zero and ninety degrees.

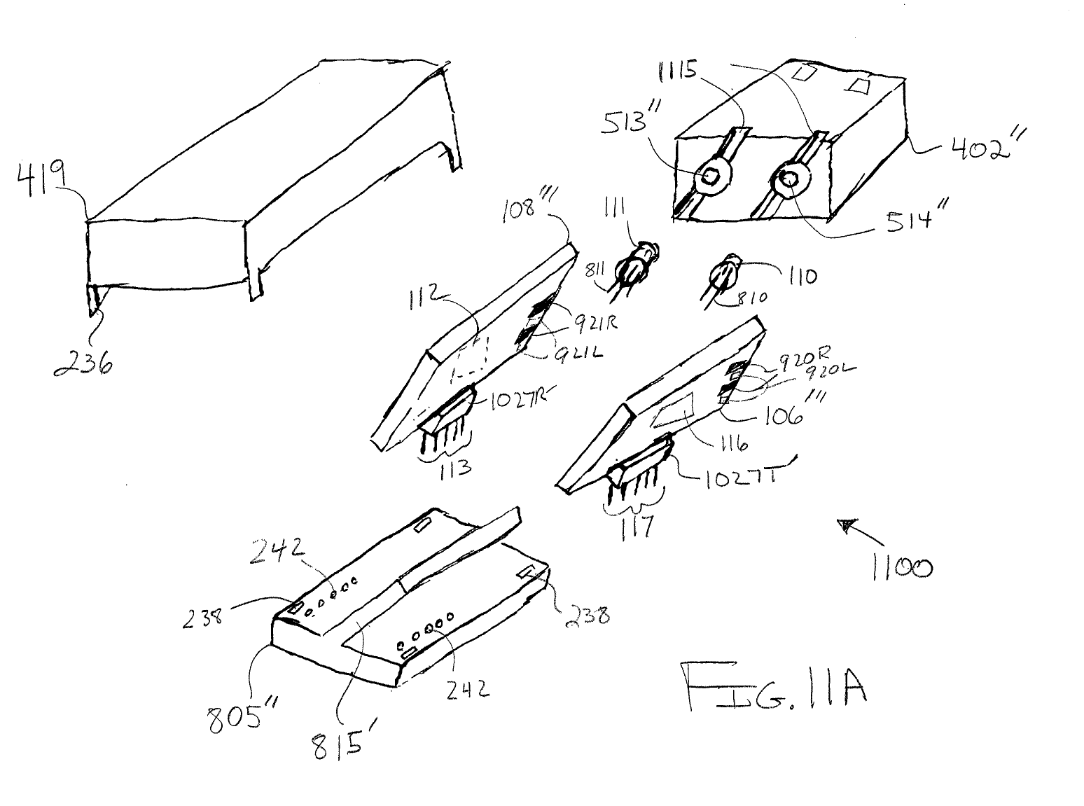

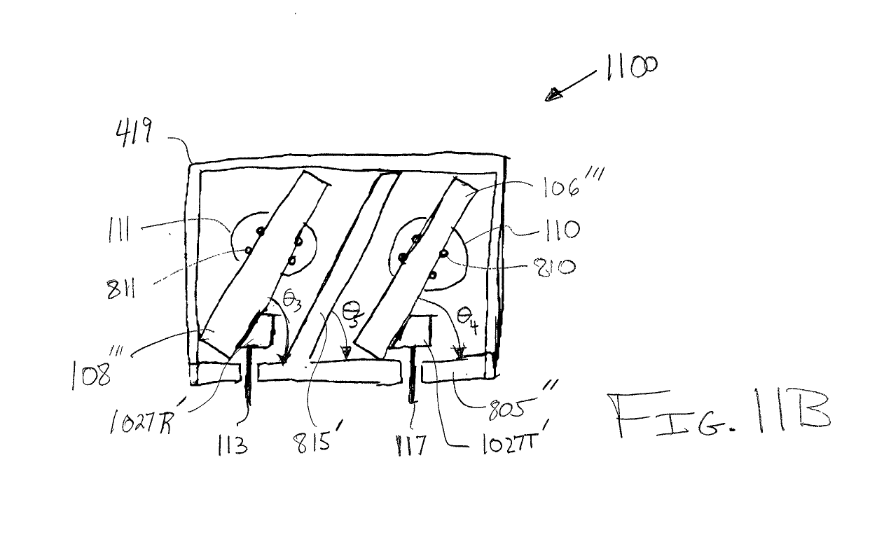

Referring now to FIG. 12A, another embodiment of the invention is illustrated. FIG. 12A illustrates an exploded view of a fiber optic module 1200. The fiber optic module 1200 has angled or slanted PCBs with respect to a horizontal or vertical axis of the fiber optic module 1200. The PCBs are angled or slanted away at top edges to form a V configuration of PCB orientation. The length of the PCBs remain parallel to the optical axis of the receiver 111 and transmitter 110. By angling the PCBs with the horizontal or vertical axis, the PCBs may be made smaller to fit a smaller form factor or alternatively the surface area can be increased. That is the available PCB surface area for mounting components can be increased for a given volume by angling the PCBs. The increased surface area can give the final assembled fiber optic module increased functionality by allowing components such as integrated circuits and passive components such as filters, capacitors, and inductors to be added. More room can also be provided in the fiber optic module 1200 for mounting larger components by angling the PCBs.

The fiber optic module 1200 includes an angled transmit PCB 106″″, an angled receive PCB 108″″, the transmitter 110, the receiver 111, an optical block 402′″, the shielded housing or cover 419, a first terminal pin header 1027T″ for the transmitter, a second terminal pin header 1027R″ for the receiver, and the baseplate 805 or 805′.

The angled transmit PCB 106″″ and the angled receive PCB 108″″ are arranged at an angle with respect to the horizontal axis of the fiber optic module as defined by a line normal to both receiver and transmitter optical axes. The angled transmit PCB 106″″ and the angled receive PCB 108″″ slant away from each other to form the V configuration. The angled transmit PCB 106″″ and the angled receive PCB 108″″ are held in place having a width that is on an angle with respect to a horizontal or vertical axis of the fiber optic module 1200. The length of the angled transmit PCB 106″″ and the angled receive PCB 108″″ are parallel to the optical axis of the receiver 111 and transmitter 110. The angled transmit PCB 106″″ includes components 116 and left and right edge traces 921L and 921R. The first terminal pin header 1027T″ has pins 117 that couple to holes of the angled transmit PCB 106″″ on one end. The angled receive PCB 108″″ includes components 112 and left and right edge traces 920L and 920R. The second terminal pin header 1027R″ has pins 113 that couple to holes of the angled receive PCB 108″″ on one end.

The transmitter 110 is a transmit optical subassembly (Tx OSA) that includes a VCSEL or other semiconductor device that transduces electrical signals into photons or a light output. The receiver 111 is a receive optical subassembly (Rx OSA) including a PIN diode or other device that converts photons or light input into electrical signals. The Tx OSA and Rx OSA are attached to physically separated transmit and receive electrical subassemblies (ESA's). In one embodiment, the transmit ESA includes the angled transmit PCB 106″″ with components 116 and the first terminal pin header 1027T″ mounted thereto. In one embodiment, the receive ESA includes the angled receive PCB 108″″ with components 112 and the second terminal pin header 1027R″ mounted thereto.

The optical block 402′″ is similar to the optical block 402 but has some modifications to accommodate the angled transmit PCB 106″″ and the angled receive PCB 108″″. The optical block 402′″ includes openings 513′″ and 514′″ to receive the receiver 111 and transmitter 110 respectively and angled slots 1215 to receive the angled transmit PCB 106″″ and the angled receive PCB 108″″. The angled slots 1215 can provide a friction fit with the angled transmit PCB 106″″ and the angled receive PCB 108″″ or glue or epoxy can be used to couple them together. The angled slots 1215 can also serve to tack the receiver 111 and transmitter 110 in place within the optical block 402′″.

The transmitter 110 couples into the opening 514′″ of the optical block 402′″. The receiver 111 couples into the opening 513′″ of the optical block 402′″. They can be held in place by either a friction fit or a glue such as an epoxy.

The transmitter 110 also couples to the transmit PCB 106″″. The terminals 810 of the transmitter 110 couple to the transmit PCB 106″″ in one embodiment. Using a straddle mount, one or more terminals 810 couple to left edge traces 920L on a left side and one or more terminals 810 couple to right edge traces 920R on a right side of the transmit PCB 106″″. In an alternate embodiment, the terminals 810 may couple to one side of the transmit PCB 106″″. In yet another alternate embodiment, the terminals 810 may couple into holes of the transmit PCB 106″″.

The receiver 111 also couples to the receive PCB 108″″. The terminals 811 of the receiver 111 couple to the receive PCB 108″″. Using a straddle mount, one or more terminals 811 couple to left edge traces 921L on a left side and one or more terminals 811 couple to right edge traces 921R on a right side of the receive PCB 108″″. In an alternate embodiment, the terminals 811 may couple to one side of the receive PCB 108″″. In yet another alternate embodiment, the terminals 811 may couple into holes of the receive PCB 108″″.

Referring now to FIG. 12B, a rear cross-sectional view of the assembled fiber optic module 1200 is illustrated. The angled receive PCB 108″″ and the angled transmit PCB 106″″ of the fiber optic module 1200 are angled away from each other with respect to a horizontal or vertical axis thereof. The first terminal pin header 1027T″ is coupled to the angled transmit PCB 1027T″ so that pins 117 are vertical with the reference axis. The second terminal pin header 1027R″ is coupled to the angled receive PCB 108″″ so that pins 113 are vertical with the reference axis. A ground plane 118 can be coupled to a side the angled receive PCB 108″″ or a ground plane 114 can be coupled to a side of the angled transmit PCB 106″″ or both similar to previously described with reference to the vertical boards and FIGS. 9B-9E. The shield housing or cover 419 couples to the baseplate 805 or 805′ around the printed circuit boards. Depending upon the width of the printed circuit boards 106″″ and 108″″ and the width of the fiber optic module 1200, the angles θ₆ and θ₇ which the printed boards make with the base or baseplate 805 or 805′ can vary between zero and ninety degrees.

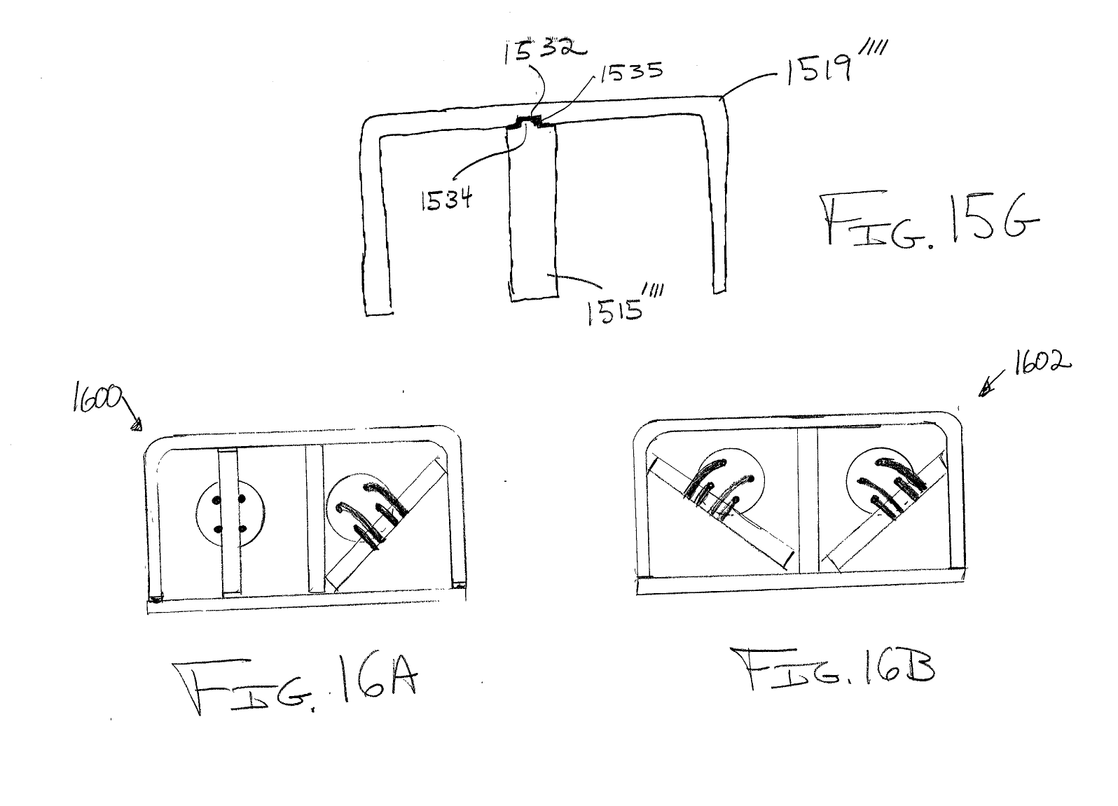

While symmetrical angles for the printed circuit boards have been illustrated, combinations can be utilized to form alternate embodiments. For example, one of the printed circuit boards may be arranged on an angle with the base so as to slant while the other printed circuit board may be arranged perpendicular to the base. FIG. 16A illustrates a fiber optic module 1600 with such an arrangement for an alternate embodiment of the invention.

Referring now to FIG. 13, a receiver optical block 402R and a transmitter optical block 402T are illustrated as an alternative to the optical block 402 or 402′. Previously the fiber optic modules were described and illustrate using a single optical block 402 or 402′. However, the optical blocks 402R and 402T can provide similar functionality to the single optical block 402 or 402′. The receiver optical block 402R couples to the receiver 111 while the transmit optical block 402T couples to the transmitter 110. The receiver 111 and transmitter 110 can be press fit into the openings 513 and 514 or alternatively a glue or epoxy can inserted into the tacking holes to couple them together. Each optical receiver optical block 402R and transmit optical block 402T provides alignment to an optical fiber and may include a lens. If one more receiver channels are desired, one or more receiver optical blocks 402R can be utilized. If one or more transmit channels are desired, one or more transmit optical blocks 402T can be utilized.

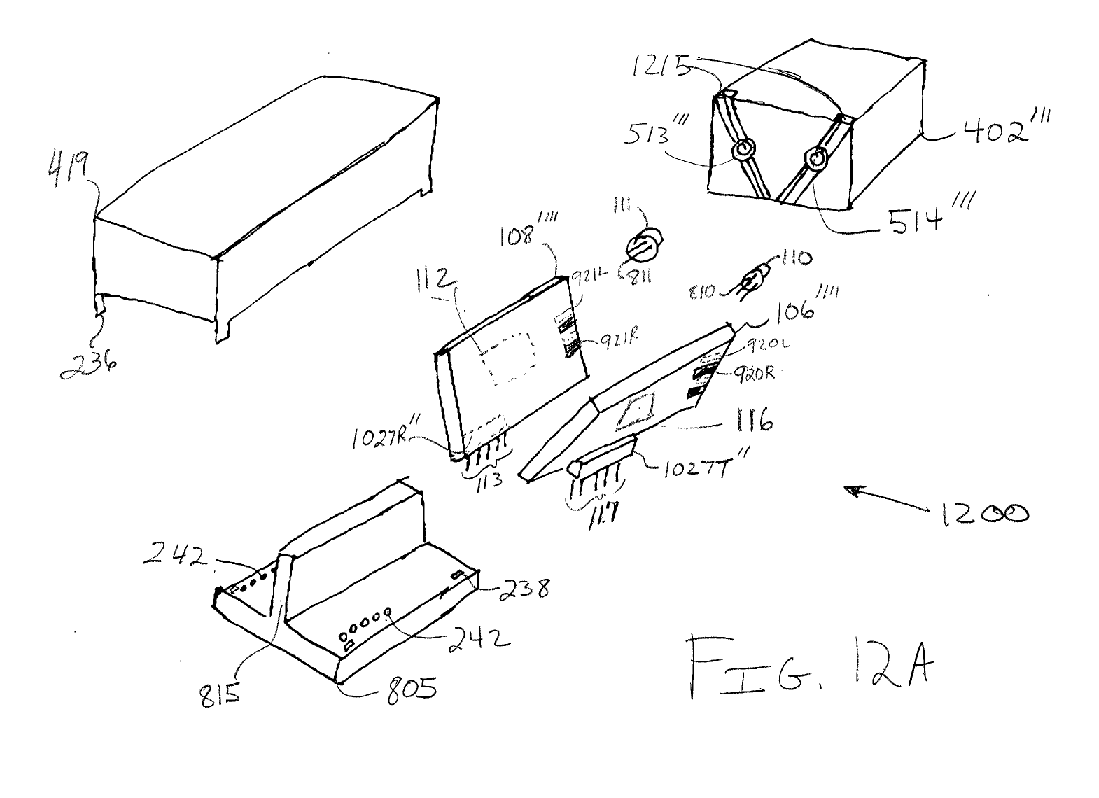

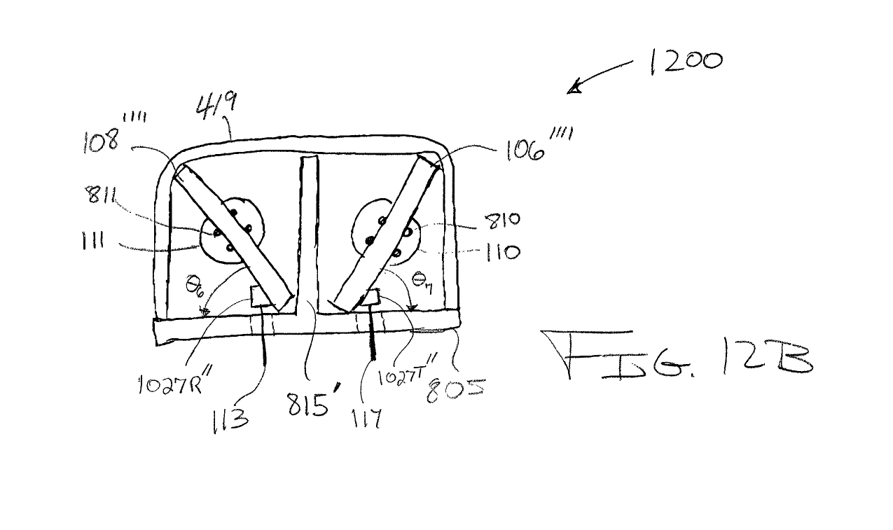

While pins 113 and 117 of the fiber optic modules (100, 400, 800, 900, 1000, 1100, or 1200) facilitate soldering to a host printed circuit board, they can also be plugged into a socket 1402 on a host printed circuit board 1404 as illustrated in FIG. 14A. Alternatively, the pins 113 and 117 can each be replaced with one or more sockets 1406R and 1406T coupled to the printed circuit boards on the bottom edge or back edge. In the case of sockets 1406R and 1406T on the bottom edges of the printed circuit boards, the fiber optic module (100, 400, 800, 900, 1000, 1100, or 1200) plugs vertically or downward on sockets 1408R and 1408T for example of the host printed circuit board 1404′ as illustrated by FIG. 14B. In the case of a socket or sockets 1416R and 1416T on the back edge of the printed circuit boards, the fiber optic module (100, 400, 800, 900, 1000, 1100, or 1200) plugs horizontally or inward into a socket or sockets 1418R and 1418T of the host printed circuit board 1404″.

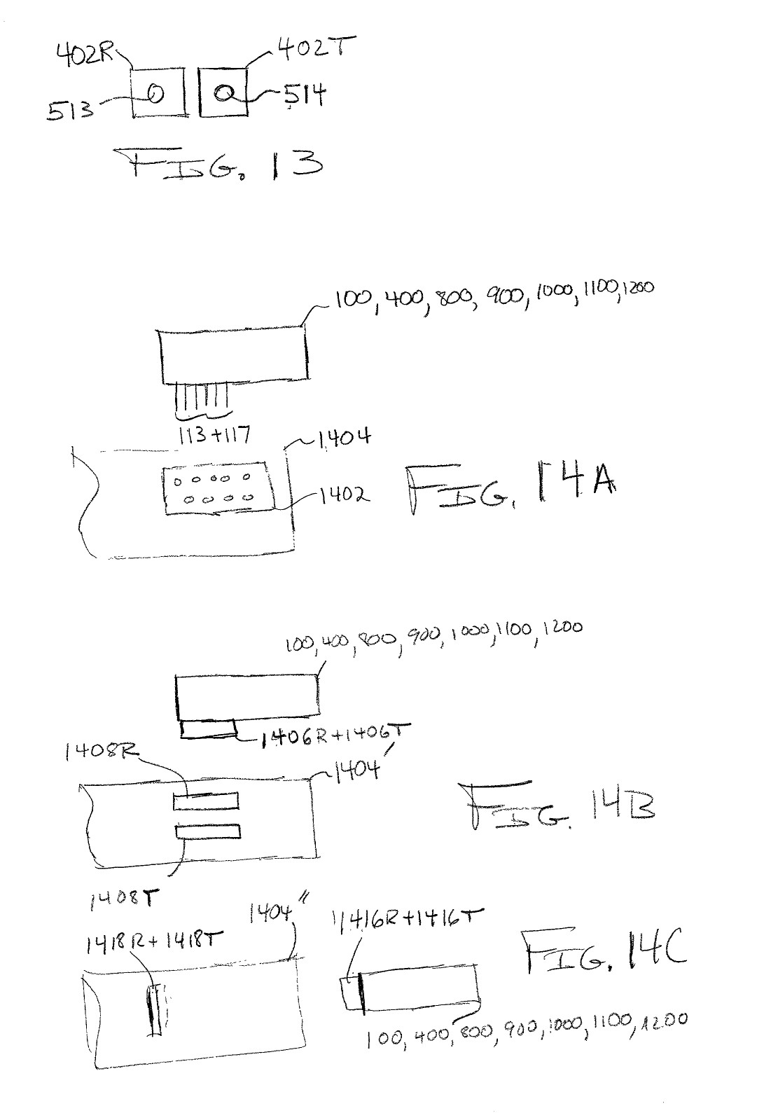

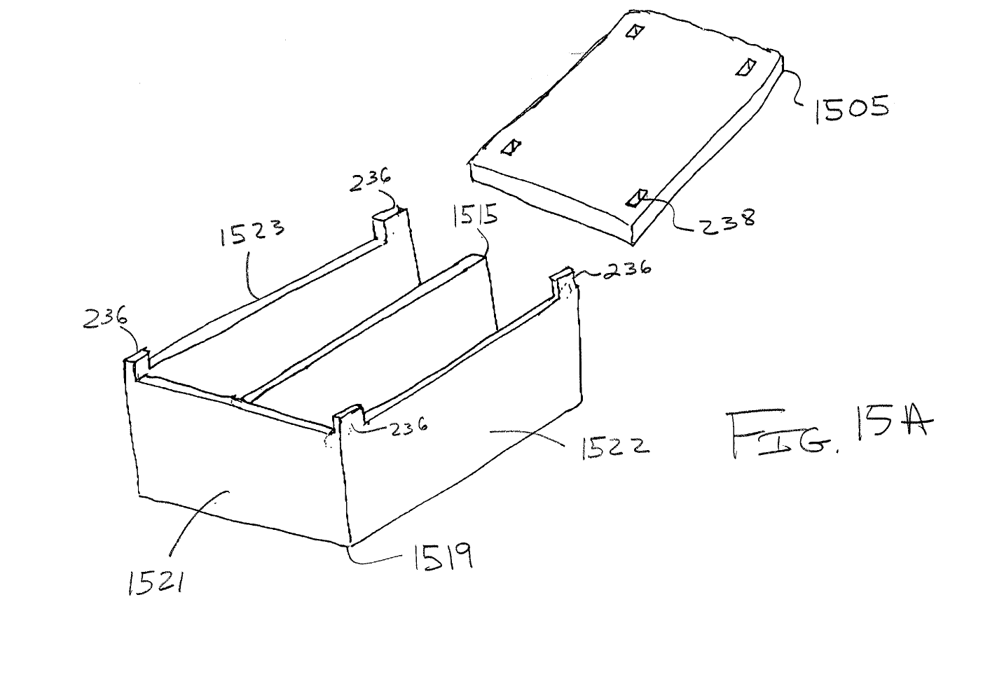

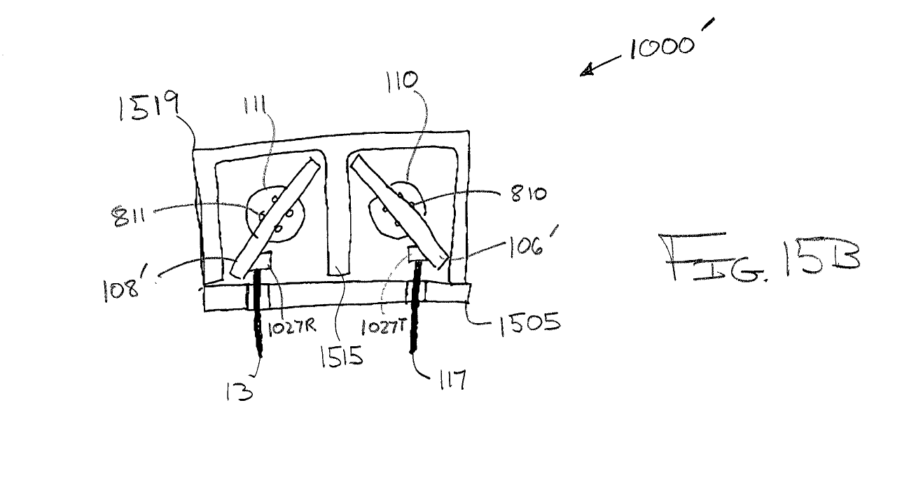

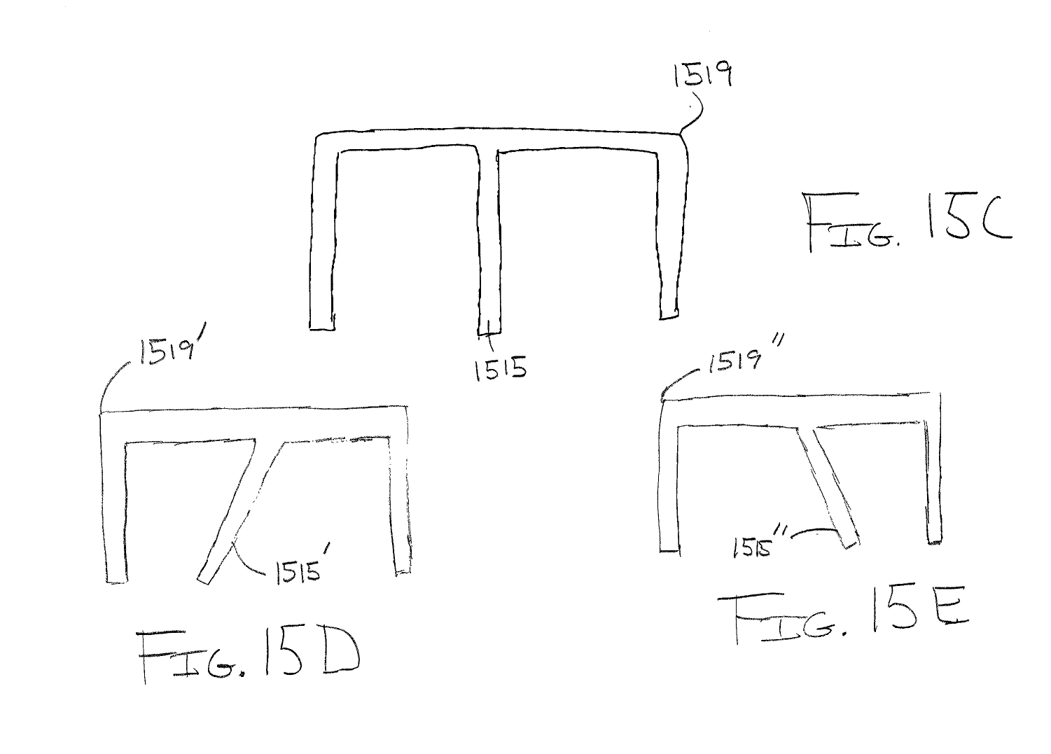

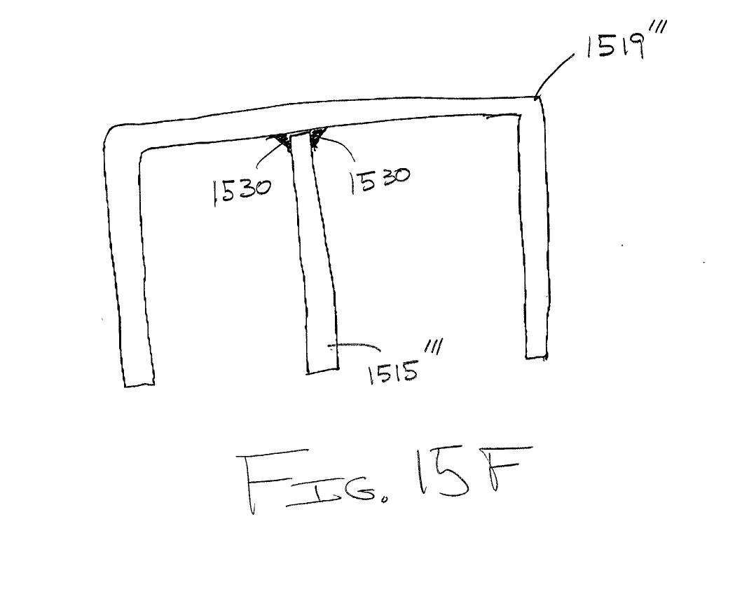

Referring now FIG. 15A, an alternate embodiment of a shielded housing or cover 1519 and an alternate base 1505. The shielded housing or cover 1519 includes a center inner septum 1515 incorporated as part of the housing or cover to isolate a transmit channel from a receive channel or one channel from another channel. The center inner septum 1515 splits the fiber optic module into a left side and a right side as does the other septums described herein. The housing or cover 1519 further includes a back side 1521, a left side 1522, a right side 1523 and clips or tabs 236. A front side 1524 of the housing or cover 1519 is open to couple to the optical block 402 and/or a nose.

The alternate base 1505 has no septum and may include clip openings or slots 238. Alternately, a base is without the clip openings or slots 238 such that the clips or tabs 236 of the housing or cover are bent over and around the base.

Referring now to FIG. 15B, a cross sectional view of a fiber optic module 1000′ utilizing the alternate embodiment of the shielded housing or cover 1519 and base 1505 is illustrated. The fiber optic module 1000′ is similar to fiber optic module 1000 as described with reference to FIGS. 10A-10B but for the alternate shielded housing or cover 1519 and the alternate base 1505.

Referring now to FIG. 15C, a cross sectional view of the alternate embodiment of the shielded housing or cover 1519 is illustrated. The shielded housing or cover 1519 is a monolithic or integrated shielded housing or cover incorporating the septum 1515. The shielded housing or cover 1519 can be formed of a metal, a plastic or other solid material. The shielded housing or cover 1519 if made of metal, can be formed by forging, stamping or machining. Lower costs methods to fabricate the shielded housing or cover 1519 include injection, transfer, or blow molding the shape out of plastic. The plastic can then be plated, painted or otherwise coated with a conductive material, if conductivity is desired. Likewise a metal part can be overcoated with a non-conductive material if conductivity is not desired.

Referring now to FIG. 15D and FIG. 15E, the septum can be angled as well to accommodate parallel angled PCB boards as illustrated by the septum 1515′ of the shielded housing or cover 1519′ and the septum 1515″ of the shielded housing or cover 1519″.

Referring now to FIG. 15F, the septum can be formed separately from the housing or cover and coupled thereto. The shielded housing or cover 1519′″ includes a septum 1515′″ which is formed separately and coupled together. The septum 1515′″ can be coupled to the outer housing by using fusion techniques such as soldering, welding, or melting. FIG. 15F illustrates the fuse links 1530 (solder, weld, etc) coupling the septum 1515′″ to the outer housing of the shielded housing or cover 1519′″.

Referring now to FIG. 15G, the septum can be formed separately from the housing or cover and coupled thereto by alternate means. FIG. 15G illustrates the shielded housing or cover 1519″″ including a septum 1515″″ which is formed separately and coupled together. The outer cover of the shielded housing or cover 1519″″ includes a groove 1532 and the septum 1515″″ includes a tongue 1534 to form a tongue and groove system. A glue, adhesive or epoxy 1535 is applied between the tongue and groove system which may be conductive or non-conductive to couple the outer housing and the septum 1515″″ together to form the shielded housing or cover 1519″″.

The fiber optic modules previously described with reference to FIGS. 8A-15G were illustrated with the optoelectronic devices (transmitter 110 and receiver 111) having its terminals coupled to the printed circuit boards using a straddle mount. However, one or all of the optoelectronic devices may have their terminals coupled to the printed circuit boards using a through hole mount. In a straddle mount, the optoelectronic device (i.e. the transmitter 110 or the receiver 111) has its optical axis nearly in-line and parallel with a plane of the printed circuit board. In a through hole mount, the optoelectronic device (i.e. the transmitter 110 or the receiver 111) has its optical axis nearly parallel with a plane of the printed circuit board.

Referring now to FIG. 16A, a rear cross-section of a fiber optic module 1600 is illustrated having a first optoelectronic device with its terminals coupled to a first printed circuit board in a straddle mount configuration and a second optoelectronic device with its terminals coupled to a second printed circuit board in a through hole mount configuration. Alternatively, both the first optoelectronic device the second optoelectronic device may have their terminals coupled to their respective printed circuit boards in a through hole mount configuration as illustrated by the rear cross-section of fiber optic module 1602 of FIG. 16B.

The previous detailed description describes fiber optic modules as including a receiver and transmitter. However, one of ordinary skill can see that a fiber optic module may be a receiver only or a transmitter only such that only one board type is used. Additionally, the previous detailed description described one receive channel and one transmit channel. However, the invention may be extended to a plurality of channels in parallel which can be all transmit channels, all receive channels or both receive and transmit channels into multiple fiber optic cables.

As those of ordinary skill will recognize, the invention has a number of advantages over the prior art.

The preferred embodiments of the invention are thus described. While the invention has been described in particular embodiments, the invention should not be construed as limited by such embodiments, but rather construed according to the claims that follow below.

What is claimed is:

1. A fiber optic module for coupling photons between optoelectronic devices and optical fibers, the fiber optic module comprising:
a base;
a first printed circuit board (PCB) arranged at a first angle with the base and parallel to a first optical axis of a first optoelectronic device, the first optoelectronic device having terminals coupled to the first printed circuit board; and
a second printed circuit board (PCB) arranged at a second angle with the base and parallel to a second optical axis of a second optoelectronic device, the second optoelectronic device having terminals coupled to the second printed circuit board.

2. The fiber optic module of claim 1 further comprising:
a housing coupled to the base.

3. The fiber optic module of claim 2 wherein,
the housing is a shielded housing to encase the first and second printed circuit boards to reduce electromagnetic interference (EMI).

4. The fiber optic module of claim 3 wherein,
the housing has an inner septum to separate the fiber optic module into a first side and a second side and the inner septum is a conductive shield to reduce crosstalk electromagnetic radiation.

5. The fiber optic module of claim 1 wherein,
the base has a first and second opening;
the first printed circuit board has a plurality of pins extending through the first opening in the base to couple to the system; and
the second printed circuit board has a plurality of pins extending through the second opening in the base to couple to the system.

6. The fiber optic module of claim 5 wherein,
the first and second opening in the base are a plurality of pin holes in the base.

7. The fiber optic module of claim 5 wherein,
the first and second opening in the base are a first and second cutout in the base.

8. The fiber optic module of claim 1 wherein, the first and second printed circuit boards further comprises:
electrical components coupled between the first and second optoelectronic device and the plurality of pins of the first printed circuit board and between the and second optoelectronic device and the plurality of pins of the second printed circuit board, the electrical components for controlling the first and second optoelectronic devices.

9. The fiber optic module of claim 1 wherein, the first printed circuit board further comprises:
a ground plane to reduce electro-magnetic fields generated by the electrical components.

10. The fiber optic module of claim 1 wherein, the second printed circuit board further comprises:
a ground plane to reduce electro-magnetic fields generated by the electrical components.

11. The fiber optic module of claim 1 further comprising:
a first optical block coupled to the first optoelectronic device, the first optical block having a first opening to receive the first optoelectronic device, and
a first lens to couple photons between the first optoelectronic device and an optical fiber.

12. The fiber optic module of claim 11 further comprising:
a nose coupled to the base, the nose to receive an optical fiber connector and to hold an optical fiber substantially fixed and aligned with an optical opening of the optical block.

13. The fiber optic module of claim 12 further comprising:
a nose shield surrounding the nose to reduce electromagnetic interference.

14. The fiber optic module of claim 1 further comprising:
a second optical block coupled to the second optoelectronic device, the second optical block having
a second opening to receive the second optoelectronic device, and
a second lens to couple photons between the second optoelectronic device and an optical fiber.

15. The fiber optic module of claim 11 further comprising:
a second optical block coupled to the second optoelectronic device, the second optical block having
a second opening to receive the second optoelectronic device, and
a second lens to couple photons between the second optoelectronic device and an optical fiber.

16. The fiber optic module of claim 1 further comprising:
an optical block coupled to the first and second optoelectronic devices, the optical block having
first and second openings to receive the first and second optoelectronic devices,
a first lens to couple photons between the first optoelectronic device and a first optical fiber, and
a second lens to couple photons between the second optoelectronic device and a second optical fiber.

17. The fiber optic module of claim 16, wherein,
the first lens of the optical block to launch photons into the first optical fiber from the first optoelectronic device.

18. The fiber optic module of claim 16, wherein,
the second lens of the optical block is a focusing lens to receive photons from the second optical fiber and to couple them to the second optoelectronic device.

19. The fiber optic module of claim 16 further comprising:
a nose coupled to the base, the nose to receive an optical fiber connector and to hold an optical fiber substantially fixed and aligned with an optical opening of the optical block.

20. The fiber optic module of claim 19 further comprising:
a nose shield surrounding the nose to reduce electromagnetic interference.

21. The fiber optic module of claim 13, wherein,
the first optoelectronic device is a photodetector.

22. The fiber optic module of claim 13, wherein,
the second optoelectronic device is an emitter.

23. The fiber optic module of claim 22, wherein,
the emitter is a vertical cavity surface emitting laser (VCSEL).

24. A fiber optic transceiver for coupling photons between optoelectronic devices and optical fibers, the fiber optic transceiver comprising:
a base;
a first internal printed circuit board (PCB) arranged at a first angle with the base and parallel to a first optical axis of a first optoelectronic device, the first internal printed circuit board having a first connecting means to couple to an external printed circuit board, the first optoelectronic device having terminals coupled to the first internal printed circuit board;
a second internal printed circuit board (PCB) arranged at a second angle with the base and parallel to a second optical axis of a second optoelectronic device, the second internal printed circuit board having a second connecting means to couple to an external printed circuit board, the second optoelectronic device having terminals coupled to the second printed circuit board;
a housing coupled to the base, the housing to cover the first internal printed circuit board and the second internal printed circuit board.

25. The fiber optic transceiver of claim 24 wherein,
the first internal printed circuit board further comprises:
first electrical components coupled between the first optoelectronic device and the first connecting means on a first side of the first internal printed circuit board, the first electrical components for controlling the first optoelectronic device, and
a first ground plane coupled to a second side of the first internal printed circuit board to reduce electro-magnetic fields; and,
the second internal printed circuit board further comprises:
second electrical components coupled between the second optoelectronic device and the second connecting means on a first side of the second internal printed circuit board, the second electrical components for controlling the second optoelectronic device.

26. The fiber optic transceiver of claim 25 wherein,
the second internal printed circuit board further comprises:
a second ground plane coupled to a second side of the second internal printed circuit board to reduce electro-magnetic fields.

27. The fiber optic transceiver of claim 24, wherein,
the first connecting means and the second connecting means are pins to couple to pin receptacles of the external printed circuit board.

28. The fiber optic transceiver of claim 24, wherein,
the first connecting means and the second connecting means are connectors to couple into connectors of the external printed circuit board.

29. The fiber optic transceiver of claim 24 further comprising:
an optical block coupled to the first optoelectronic device and the second optoelectronic device, the optical block having a first lens to couple photons between the first optoelectronic device and a first optical fiber and a second lens to couple photons between the second optoelectronic device and a second optical fiber.

30. The fiber optic transceiver of claim 24 further comprising:
a first optical block coupled to the first optoelectronic device, the first optical block having a first lens to couple photons between the first optoelectronic device and a first optical fiber, and
a second optical block coupled to the second optoelectronic device, the second optical block having a second lens to couple photons between the second optoelectronic device and a second optical fiber.

31. The fiber optic transceiver of claim 24 further comprising:
a nose coupled to the base, the nose for receiving an optical fiber connector and holding a pair of optical fibers substantially fixed and aligned with the first optoelectronic device and the second optoelectronic device.

32. The fiber optic transceiver of claim 31 further comprising:
a nose shield surrounding the nose to reduce electromagnetic interference.

33. The fiber optic transceiver of claim 24 further comprising:
an internal shield inserted between the first internal printed circuit board and the second internal printed circuit board, the internal shield to reduce electrical crosstalk.

34. A method of assembling a fiber optic transceiver, the method comprising:
a) providing an optical block having a lens to focus photons and an opening,
b) coupling an optoelectronic device into the opening of the optical block,
c) coupling a printed circuit board on an angle to terminals of the optoelectronic device, the printed circuit board having at least one electronics component between one terminal of the optoelectronic device and one signal trace on the printed circuit board; and
d) assembling a housing and a base together around the optical block, the optoelectronic device and the printed circuit board and wherein the printed circuit board is angled with respect to a plane of the base.

35. The method of claim 34 of assembling a fiber optic transceiver, the method further comprising:
e) prior to assembling the housing and the base, installing a nose having a fiber optic receptacle to receive a fiber optic cable.

36. The method of claim 35 of assembling a fiber optic transceiver, the method further comprising:
f) installing a nose shield over the nose.

37. The method of claim 36 of assembling a fiber optic transceiver, wherein,
the nose is non-conductive and the nose shield is conductive.

38. The method of claim 36 of assembling a fiber optic transceiver, wherein,
the housing is conductive.

39. A fiber optic module comprising:
a first optical block having a first opening to receive a first optoelectronic device;
the first optoelectronic device coupled into the first opening;
a second optical block having a second opening to receive a second optoelectronic device;
the second optoelectronic device coupled into the second opening;
a first printed circuit board coupled to terminals of the first optoelectronic device on an angle with a plane of the first optical block, the first printed circuit board parallel to a first optical axis of the first optoelectronic device; and
a second printed circuit board coupled to terminals of the second optoelectronic device on an angle with a plane of the second optical block, the second printed circuit board parallel to a second optical axis of the second optoelectronic device.

40. The fiber optic module of claim 39, wherein the fiber optic module is a fiber optic transceiver and
the first optoelectronic device is a transmitter to couple photons into a first optical fiber, and
the second optoelectronic device is a receiver to receive photons from a second optical fiber.

41. A fiber optic module comprising:
an optical block having a first opening to receive a first optoelectronic device and a second opening to receive a second optoelectronic device;
the first optoelectronic device coupled into the first opening;
the second optoelectronic device coupled into the second opening;
a base having a first guide rail and a second guide rail;
a first printed circuit board coupled to terminals of the first optoelectronic device in parallel to a first optical axis of the first optoelectronic device, the first printed circuit board coupled to the first guide rail of the base; and
a second printed circuit board coupled to terminals of the second optoelectronic device in parallel to a second optical axis of the second optoelectronic device, the second printed circuit board coupled to the second guide rail of the base.

42. The fiber optic module of claim 41 further comprising:
a housing coupled to the base.

43. The fiber optic module of claim 42 wherein,
the housing is a shielded housing to encase the first and second printed circuit board to reduce electromagnetic interference (EMI).

44. The fiber optic module of claim 41 wherein,
the base has a pair of cutouts to allow pins of the first printed circuit board and pins of the second printed circuit board to extend through.

45. The fiber optic module of claim 41 wherein,
the base has a pair of openings to allow pins of the first printed circuit board and pins of the second printed circuit board to extend through.

46. The fiber optic module of claim 41, wherein the fiber optic module is a fiber optic transceiver and
the first optoelectronic device is a transmitter to couple photons into a first optical fiber, and
the second optoelectronic device is a receiver to receive photons from a second optical fiber.

47. A fiber optic module comprising:
an optical block having a first opening to receive a first optoelectronic device and a second opening to receive a second optoelectronic device;
the first optoelectronic device coupled into the first opening;
the second optoelectronic device coupled into the second opening;
a base having a first pair of brackets on one side and a second pair of brackets on an opposite side;
a first printed circuit board coupled to terminals of the first optoelectronic device in parallel to a first optical axis of the first optoelectronic device, the first printed circuit board coupled to the first pair of brackets of the base; and
a second printed circuit board coupled to terminals of the second optoelectronic device in parallel to a second optical axis of the second optoelectronic device, the second printed circuit board coupled to the second pair of brackets of the base.

48. The fiber optic module of claim 47 further comprising:
a housing coupled to the base.

49. The fiber optic module of claim 48 wherein,
the housing is a shielded housing to encase the first and second printed circuit board to reduce electromagnetic interference (EMI).

50. The fiber optic module of claim 47 wherein,
the base has a pair of cutouts to allow pins of the first printed circuit board and pins of the second printed circuit board to extend through.

51. The fiber optic module of claim 47 wherein,
the base has a pair of openings to allow pins of the first printed circuit board and pins of the second printed circuit board to extend through.

52. The fiber optic module of claim 47, wherein the fiber optic module is a fiber optic transceiver and
the first optoelectronic device is a transmitter to couple photons into a first optical fiber, and
the second optoelectronic device is a receiver to receive photons from a second optical fiber.

53. A fiber optic module comprising:
an optical block having a first opening to receive a first optoelectronic device and a second opening to receive a second optoelectronic device, the optical block further having a first slot to receive an end of a first printed circuit board and a second slot to receive an end of a second printed circuit board;
the first optoelectronic device coupled into the first opening;
the second optoelectronic device coupled into the second opening;
a base;
a first printed circuit board coupled to terminals of the first optoelectronic device in parallel to a first optical axis of the first optoelectronic device, the first printed circuit board coupled to the first slot of the optical block; and
a second printed circuit board coupled to terminals of the second optoelectronic device in parallel to a second optical axis of the second optoelectronic device, the second printed circuit board coupled to the second slot of the optical block.

54. The fiber optic module of claim 53 further comprising:
a housing coupled to the base.

55. The fiber optic module of claim 55 wherein,
the housing is a shielded housing to encase the first and second printed circuit board to reduce electromagnetic interference (EMI).

56. The fiber optic module of claim 53 wherein,
the base has a pair of cutouts to allow pins of the first printed circuit board and pins of the second printed circuit board to extend through.

57. The fiber optic module of claim 53 wherein,
the base has a pair of openings to allow pins of the first printed circuit board and pins of the second printed circuit board to extend through.

58. The fiber optic module of claim 53, wherein the fiber optic module is a fiber optic transceiver and
the first optoelectronic device is a transmitter to couple photons into a first optical fiber, and
the second optoelectronic device is a receiver to receive photons from a second optical fiber.

59. A fiber optic module comprising:
an optical block having a first opening to receive a first optoelectronic device and a second opening to receive a second optoelectronic device;
the first optoelectronic device coupled into the first opening;
the second optoelectronic device coupled into the second opening;
a base;
a first printed circuit board on a first side of the fiber optical module coupled to terminals of the first optoelectronic device in parallel to a first optical axis of the first optoelectronic device;
a second printed circuit board on the first side of the fiber optic module coupled to the first printed circuit board and having a first connecting means to couple to an external printed circuit board;
a third printed circuit board on a second side of the fiber optic module coupled to terminals of the second optoelectronic device in parallel to a second optical axis of the second optoelectronic device; and
a fourth printed circuit board on the second side of the fiber optic module coupled to the third printed circuit board and having a second connecting means to couple to the external printed circuit board.

60. The fiber optic module of claim 59 further comprising:
a housing coupled to the base.

61. The fiber optic module of claim 60 wherein,
the housing is a shielded housing to encase the first and second, third and fourth printed circuit boards to reduce electromagnetic interference (EMI).

62. The fiber optic module of claim 59 wherein,
the base has a pair of cutouts to allow pins of the first printed circuit board and pins of the second printed circuit board to extend through.

63. The fiber optic module of claim 59 wherein,
the base has a pair of openings to allow pins of the first printed circuit board and pins of the second printed circuit board to extend through.

64. The fiber optic module of claim 59, wherein the fiber optic module is a fiber optic transceiver and
the first optoelectronic device is a transmitter to couple photons into a first optical fiber, and
the second optoelectronic device is a receiver to receive photons from a second optical fiber.

65. The fiber optic module of claim 59, wherein,
the first connecting means and the second connecting means are pins to couple to pin receptacles of the external printed circuit board.

66. The fiber optic module of claim 59, wherein,
the first connecting means and the second connecting means are connectors to couple into connectors of the external printed circuit board.

67. The fiber optic module of claim 59, wherein,
the first connecting means and the second connecting means are pin headers including a plurality of pins to couple the external printed circuit board.

68. The fiber optic module of claim 59 further comprising:
a housing having an opening at an end coupled to the base.

69. The fiber optic module of claim 68, wherein,
the first connecting means and the second connecting means are connectors to couple into connectors of the external printed circuit board through the opening at the end of the housing.

70. The fiber optic module of claim 59 wherein,
the base includes an inner septum to separate the fiber optic module into the first side and the second side.

71. The fiber optic module of claim 59 wherein,
the first and second and the third and fourth printed circuit board in a dual stack horizontal configuration.

72. A fiber optic module comprising:
an optical block having a first opening to receive a first optoelectronic device and a second opening to receive a second optoelectronic device;
the first optoelectronic device coupled into the first opening;
the second optoelectronic device coupled into the second opening;
a base;
a first angled printed circuit board (PCB) coupled to terminals of the first optoelectronic device in parallel to a first optical axis of the first optoelectronic device, the first angled printed circuit board arranged at a first angle to slant inward from the base; and
a second angled printed circuit board (PCB) coupled to terminals of the second optoelectronic device in parallel to a second optical axis of the second optoelectronic device, the second angled printed circuit board arranged at a second angle to slant inward from the base.

73. The fiber optic module of claim 72 further comprising:
a housing coupled to the base.

74. The fiber optic module of claim 73 wherein,
the housing is a shielded housing to encase the first and second angled printed circuit boards to reduce electromagnetic interference (EMI).

75. The fiber optic module of claim 73 wherein,
the first angled printed circuit board and the second angled printed circuit board each have a plurality of pins to couple to a host system printed circuit board.

76. The fiber optic module of claim 75 wherein,
the base has a pair of cutouts to allow the pins of the first angled printed circuit board and the pins of the second angled printed circuit board to extend through.

77. The fiber optic module of claim 75 wherein,
the base has a pair of openings to allow the pins of the first angled printed circuit board and the pins of the second angled printed circuit board to extend through.

78. The fiber optic module of claim 72, wherein the fiber optic module is a fiber optic transceiver and
the first optoelectronic device is a transmitter to couple photons into a first optical fiber, and
the second optoelectronic device is a receiver to receive photons from a second optical fiber.

79. The fiber optic module of claim 72 wherein,
the first angled printed circuit board and the second angled printed circuit board each have a connector to couple to a connector of a host system printed circuit board.

80. The fiber optic module of claim 72 further comprising:
a housing having an opening at an end coupled to the base.

81. The fiber optic module of claim 80, wherein,
the first angled printed circuit board and the second angled printed circuit board each have a connector to couple to a connector of a host system printed circuit board through the opening at the end of the housing.

82. The fiber optic module of claim 72 wherein,
the base includes an inner septum to separate the fiber optic module into a first side and a second side.

83. The fiber optic module of claim 72 wherein,
the first and second angled printed circuit boards are in an angled configuration.

84. A fiber optic module comprising:
an optical block having a first opening to receive a first optoelectronic device;
the first optoelectronic device coupled into the first opening;
a motherboard printed circuit board;
a first daughterboard printed circuit board (PCB) coupled to terminals of the first optoelectronic device in parallel to a first optical axis of the first optoelectronic device, the first daughterboard printed circuit board coupled at a first angle to the motherboard printed circuit board.

85. The fiber optic module of claim 84 further comprising:
a housing coupled to the base.

86. The fiber optic module of claim 85 wherein,
the housing is a shielded housing to encase the first daughterboard printed circuit board to reduce electromagnetic interference (EMI).

87. The fiber optic module of claim 84 wherein,
the first angle is substantially ninety degrees so that the first daughterboard printed circuit board is coupled perpendicular to the motherboard printed circuit board.

88. The fiber optic module of claim 84 wherein,
the motherboard printed circuit board has a plurality of pins to couple to an external printed circuit board.

89. The fiber optic module of claim 84 wherein,
the motherboard printed circuit board has a connector to couple to a connector of an external printed circuit board.

90. The fiber optic module of claim 84 wherein,
the first daughterboard printed circuit board has traces coupled to traces of the motherboard printed circuit board.

91. The fiber optic module of claim 90 wherein,
the traces of first daughterboard printed circuit board are coupled traces of the motherboard printed circuit board by solder joints.

92. The fiber optic module of claim 84 wherein,
the optical block further having a second opening to receive a second optoelectronic device, and
the fiber optic module further comprises,
a second optoelectronic device coupled into the second opening, and
a second daughterboard printed circuit board (PCB) coupled to terminals of the second optoelectronic device in parallel to a second optical axis of the second optoelectronic device, the second daughterboard printed circuit board coupled at a second angle to the motherboard printed circuit board.

93. The fiber optic module of claim 92, wherein the fiber optic module is a fiber optic transceiver and
the first optoelectronic device is a transmitter to couple photons into a first optical fiber, and
the second optoelectronic device is a receiver to receive photons from a second optical fiber.

94. The fiber optic module of claim 92 further comprising:
a housing coupled to the base.

95. The fiber optic module of claim 94 wherein,
the housing is a shielded housing to encase the first daughterboard printed circuit board to reduce electromagnetic interference (EMI).

96. The fiber optic module of claim 92 wherein,
the first angle is substantially ninety degrees so that the first daughterboard printed circuit board is coupled perpendicular to the motherboard printed circuit board.

97. The fiber optic module of claim 96 wherein,
the second angle is substantially ninety degrees so that the second daughterboard printed circuit board is coupled perpendicular to the motherboard printed circuit board.

98. The fiber optic module of claim 92 wherein,
the motherboard printed circuit board has a plurality of pins to couple to an external printed circuit board.

99. The fiber optic module of claim 92 wherein,
the motherboard printed circuit board has a connector to couple to a connector of an external printed circuit board.

100. The fiber optic module of claim 84 wherein,
the first daughterboard printed circuit board has traces coupled to traces of the motherboard printed circuit board, and
the second daughterboard printed circuit board has traces coupled to traces of the motherboard printed circuit board.

101. The fiber optic module of claim 90 wherein,
the traces of first daughterboard printed circuit board are coupled traces of the motherboard printed circuit board by solder joints, and
the traces of second daughterboard printed circuit board are coupled traces of the motherboard printed circuit board by solder joints.

102. The fiber optic module of claim 92 further comprising:
a housing having an opening at an end coupled to the base.

103. The fiber optic module of claim 102, wherein,
the first daughterboard printed circuit board and the second daughterboard printed circuit board each have a connector to couple to a connector of a host system printed circuit board through the opening at the end of the housing.

104. The fiber optic module of claim 92 wherein,
the motherboard printed circuit board includes an inner septum to separate the fiber optic module into a first side and a second side.

105. The fiber optic module of claim 104 wherein,
the inner septum is a conductive shield to reduce crosstalk electromagnetic radiation.

106. The fiber optic module of claim 92 further comprising:
a housing having an inner septum to separate the fiber optic module into a first side and a second side, the housing coupled to the base.

107. The fiber optic module of claim 106 wherein,
the housing is a conductive shielded housing to encase the first daughterboard printed circuit board to reduce electromagnetic interference (EMI) and the septum is a conductive shield to reduce crosstalk electromagnetic radiation.

108. The fiber optic module of claim 92 wherein,
the first and second daughterboard printed circuit boards are vertical printed circuit boards and the motherboard printed circuit board is a horizontal motherboard printed circuit board.

109. A fiber optic module comprising:
an optical block having a first opening to receive a first optoelectronic device and a second opening to receive a second optoelectronic device;
the first optoelectronic device coupled into the first opening;
the second optoelectronic device coupled into the second opening;
a base;
a first angled printed circuit board (PCB) coupled to terminals of the first optoelectronic device in parallel to a first optical axis of the first optoelectronic device, the first angled printed circuit board arranged at a first angle with the base;
a second angled printed circuit board (PCB) coupled to terminals of the second optoelectronic device in parallel to a second optical axis of the second optoelectronic device, the second angled printed circuit board arranged at a second angle with the base; and
wherein the first angled printed circuit board and the second angled printed circuit board are substantially parallel to each other.

110. The fiber optic module of claim 109 further comprising:
a housing coupled to the base.

111. The fiber optic module of claim 110 wherein,
the housing is a shielded housing to encase the first and second angled printed circuit boards to reduce electromagnetic interference (EMI).

112. The fiber optic module of claim 109 wherein,
the first angled printed circuit board and the second angled printed circuit board each have a plurality of pins to couple to a host system printed circuit board.

113. The fiber optic module of claim 112 wherein,
the base has a pair of cutouts to allow the pins of the first angled printed circuit board and the pins of the second angled printed circuit board to extend through.

114. The fiber optic module of claim 112 wherein,
the base has a pair of openings to allow the pins of the first angled printed circuit board and the pins of the second angled printed circuit board to extend through.

115. The fiber optic module of claim 109, wherein the fiber optic module is a fiber optic transceiver and
the first optoelectronic device is a transmitter to couple photons into a first optical fiber, and
the second optoelectronic device is a receiver to receive photons from a second optical fiber.

116. The fiber optic module of claim 109 wherein,
the first angled printed circuit board and the second angled printed circuit board each have a connector to couple to a connector of a host system printed circuit board.

117. The fiber optic module of claim 109 further comprising:
a housing having an opening at an end coupled to the base.

118. The fiber optic module of claim 117, wherein,
the first angled printed circuit board and the second angled printed circuit board each have a connector to couple to a connector of a host system printed circuit board through the opening at the end of the housing.

119. The fiber optic module of claim 109 wherein,
the base includes an inner septum to separate the fiber optic module into a first side and a second side.

120. The fiber optic module of claim 109 further comprising:
a housing having an inner septum to separate the fiber optic module into a first side and a second side, the housing coupled to the base.

121. The fiber optic module of claim 120 wherein,
the housing is a conductive shielded housing to encase the first daughterboard printed circuit board to reduce electromagnetic interference (EMI) and the septum is a conductive shield to reduce crosstalk electromagnetic radiation.

122. The fiber optic module of claim 109 wherein,
the first and second angled printed circuit boards are in a parallel angled configuration.

123. A fiber optic module comprising:
an optical block having a first opening to receive a first optoelectronic device and a second opening to receive a second optoelectronic device;
the first optoelectronic device coupled into the first opening;
the second optoelectronic device coupled into the second opening;
a base;
a first angled printed circuit board (PCB) coupled to terminals of the first optoelectronic device in parallel to a first optical axis of the first optoelectronic device, the first angled printed circuit board arranged at a first angle to slant outward from the base; and
a second angled printed circuit board (PCB) coupled to terminals of the second optoelectronic device in parallel to a second optical axis of the second optoelectronic device, the second angled printed circuit board arranged at a second angle to slant outward from the base.

124. The fiber optic module of claim 123 further comprising:
a housing coupled to the base.

125. The fiber optic module of claim 124 wherein,
the housing is a shielded housing to encase the first and second angled printed circuit boards to reduce electromagnetic interference (EMI).

126. The fiber optic module of claim 123 wherein,
the first angled printed circuit board and the second angled printed circuit board each have a pin header with a plurality of pins to couple to a host system printed circuit board.

127. The fiber optic module of claim 123 wherein,
the first angled printed circuit board and the second angled printed circuit board each have a plurality of pins to couple to a host system printed circuit board.

128. The fiber optic module of claim 127 wherein,
the base has a pair of cutouts to allow the pins of the first angled printed circuit board and the pins of the second angled printed circuit board to extend through.

129. The fiber optic module of claim 127 wherein,
the base has a pair of openings to allow the pins of the first angled printed circuit board and the pins of the second angled printed circuit board to extend through.

130. The fiber optic module of claim 123, wherein the fiber optic module is a fiber optic transceiver and
the first optoelectronic device is a transmitter to couple photons into a first optical fiber, and
the second optoelectronic device is a receiver to receive photons from a second optical fiber.

131. The fiber optic module of claim 123 wherein,
the first angled printed circuit board and the second angled printed circuit board each have a connector to couple to a connector of a host system printed circuit board.

132. The fiber optic module of claim 123 further comprising:
a housing having an opening at an end coupled to the base.

133. The fiber optic module of claim 132, wherein,
the first angled printed circuit board and the second angled printed circuit board each have a connector to couple to a connector of a host system printed circuit board through the opening at the end of the housing.

134. The fiber optic module of claim 123 wherein,
the base includes an inner septum to separate the fiber optic module into a first side and a second side.

135. The fiber optic module of claim 123 further comprising:
a housing having an inner septum to separate the fiber optic module into a first side and a second side, the housing coupled to the base.

136. The fiber optic module of claim 135 wherein,
the housing is a conductive shielded housing to encase the first daughterboard printed circuit board to reduce electromagnetic interference (EMI) and the septum is a conductive shield to reduce crosstalk electromagnetic radiation.

137. The fiber optic module of claim 123 wherein,
the first and second angled printed circuit boards are in an angled configuration.

138. The fiber optic module of claim 123 wherein,
the first and second angled printed circuit boards are in an V configuration.
